(19) United States
(12) Patent Application Publication
(10) Pub. No.: US 2009/0027322 A1
(43) Pub. Date: Jan. 29, 2009

(54) Display Apparatus and Driving Method Thereof

(76) Inventor: Yukihiko Hosotani, Suzuka-shi Mie (JP)

Correspondence Address: HARNESS, DICKEY & PIERCE, P.L.C., P.O. BOX 8910, RESTON, VA, 20195, US

(21) Appl. No.: 12/223,333

(22) PCT Filed: Nov. 9, 2006
(86) PCT No.: PCT/JP2006/322335

§ 371 Date: Jul. 29, 2008

(30) Foreign Application Priority Data
Feb. 28, 2006 (JP) 2006-054090
Feb. 28, 2006 (JP) 2006-054091

(51) Int. Cl. G09G 3/36

(52) U.S. Cl. 345/87

(57) ABSTRACT

In one embodiment of a display apparatus, a data conversion section of a display control circuit differentiates a digital image signal when display with black insertion is performed from a digital image signal when display without black insertion is performed, based on data read out from a ROM which stores sets of information corresponding to the respective pixels. As a result the gamma characteristic of the display with black insertion is adjusted so as to conform to the gamma characteristic of the display without black insertion.

### TECHNICAL FIELD

The present invention relates to an active matrix display apparatus adopting a switching element such as a thin-film transistor and a driving method of the display apparatus. More specifically, the present invention relates to an improvement in moving image display capability of the display apparatus.

### BACKGROUND ART

In impulse-type display apparatuses such as CRTs (Cathode Ray Tubes), a turn-on period in which an image is displayed and a turn-off period in which no image is displayed are alternated in each pixel. In case of moving images, for example, human eyes do not perceive afterimage of an object because a turn-off period is provided each time an image for one screen is updated. Because of this, a background and an object are clearly distinguished and a moving image is perceived without discomfort.

On the other hand, in hold-type display apparatuses such as liquid crystal display apparatuses adopting TFTs (Thin Film Transistors, thin-film transistors), the brightness of each pixel is determined by a voltage held by each pixel capacity, and the voltage held by the pixel capacity is maintained for one frame period after update. As such, in a hold-type display apparatus, a voltage held as pixel data by a pixel capacity is maintained until the next update. Therefore an image of each frame is temporally close to the image of the directly preceding frame. This allows human eyes to perceive an afterimage of a moving object, when a moving image is displayed. An afterimage appears, for example, as if a moving object leaves trails (hereinafter, such an afterimage is termed trailing afterimage).

Hold-type display apparatuses such as active matrix liquid crystal display apparatus involve such trailing afterimages when displaying moving images. For this reason displays such as television receivers, which predominantly display moving images, have typically been impulse-type display apparatuses. However, because of recent strong demands for reduction in weight and thickness of displays such as television receivers, hold-type display apparatuses such as liquid crystal display apparatuses, which allow for reduction in weight and thickness, have rapidly been used as the aforesaid displays.

There are known methods of restraining a problem of the aforesaid trailing afterimage in hold-type display apparatuses such as active matrix liquid crystal display apparatuses. A known example of such methods is to achieve (pseudo) impulse display by inserting a period of black display into each frame period (hereinafter, black insertion) (e.g. Patent Document 1).
[Patent Document 1]
Japanese Unexamined Patent Publication No. 2003-66918 (published on Mar. 5, 2003)
[Patent Document 2]
Japanese Unexamined Patent Publication No. 9-243998 (published on Sep. 19, 1997)
[Patent Document 3]
Japanese Unexamined Patent Publication No. 11-85115 (published on Mar. 30, 1999)
[Patent Document 4]
Japanese Unexamined Patent Publication No. 2004-253827 (published on Sep. 9, 2004)
[Patent Document 5]
Japanese Unexamined Patent Publication No. 2001-296841 (published on Oct. 26, 2001)
[Patent Document 6]
Japanese Unexamined Patent Publication No. 2002-82657 (published on Mar. 22, 2002)
[Patent Document 7]
Japanese Unexamined Patent Publication No. 2004-165749 (published on Jun. 10, 2004)

### DISCLOSURE OF INVENTION

In addition to the above, impulse display may be achieved as follows.

FIG. 15 is a block diagram showing a liquid crystal display apparatus performing impulse display, together with an equivalent circuit of its display section. This liquid crystal display apparatus includes: a source driver 300 as a data signal line drive circuit; a gate driver 400 as a scanning signal line drive circuit; an active matrix display section 100; a display control circuit 200 for controlling the source driver 300 and the gate driver 400; and a grayscale voltage source 600.

The display section 100 of the liquid crystal display apparatus includes: gate lines GL1-GLm as m scanning signal lines: source lines SL1-SLn which intersects the respective gate lines GL1-GLm and are n data signal lines; and plural (m×n) pixel formation sections provided at the respective intersections of the gate lines GL1-GLm and the source lines SL1-SLn. These pixel formation sections are disposed in a matrix manner so as to form a pixel array. Each pixel formation section is constituted by: a TFT 10 which is a switching element whose gate terminal is connected to a gate line GLj passing through the corresponding intersection and whose source terminal is connected to a source line SLi passing through the corresponding intersection; a pixel electrode connected to the drain terminal of the TFT 10; a common electrode Ec which is an opposing electrode shared by the pixel formation sections; and a liquid crystal layer which is shared by the pixel formation sections and is sandwiched between the pixel electrode and the common electrode Ec. A liquid crystal capacity formed by the pixel electrode and the common electrode Ec functions as a pixel capacity Cp. To allow a pixel capacity to certainly retain a voltage, the liquid crystal capacity may be accompanied with an auxiliary capacity in a parallel manner. This auxiliary capacity is not described here and is not illustrated in the figure.

The pixel electrode of each pixel formation section receives an electric potential corresponding to an image to be displayed, by the source driver 300 and the gate driver 400. The common electrode Ec receives a predetermined electric potential Vcom from a power supply circuit which is not illustrated. As a result of this a voltage corresponding to the potential difference between the pixel electrode and the common electrode Ec is supplied to the liquid crystal, and an amount of light passing through the liquid crystal layer is controlled by the application of this voltage. Image display is performed in this way. For the control of an amount of light by the voltage application to the liquid crystal layer, a polarizing plate is used. In the liquid crystal display apparatus a polarizing plate is provided so as to achieve normally black.

The display control circuit 200 receives, from an external signal source, a digital video signal Dv representing an image to be displayed, a horizontal synchronization signal HSY and a vertical synchronization signal VSY both of which correspond to the digital video signal Dv, and a control signal Dc for controlling the display behavior. Based on the received signals Dv, HSY, VSY, and Dc, the display control circuit 200 generates and outputs, as signals for causing the display section 100 to display the image represented by the digital video signal Dv, a data start pulse signal SSP, a data clock signal SCK, a charge share control signal Csh, a digital image signal DA (corresponding to the video signal Dv) which represents the image to be displayed, a gate start pulse signal GSP, a gate clock signal GCK, and a gate driver output control signals GOE.

The video signal Dv is output as the digital image signal DA from the display control circuit 200 after an internal memory performs timing adjustment or the like according to need. The data clock signal SCK is generated as a signal for determining the operation timing of a shift register in the source driver 300. The data start pulse signal SSP is generated based on the horizontal synchronization signal HSY, as a signal which is switched to high level (H level) for a predetermined period of time in each horizontal scanning period and is transferred in the shift register. The gate start pulse signal GSP is generated based on the vertical synchronization signal VSY, as a signal which is switched to H level for a predetermined period of time in each frame period (each vertical scanning period). The gate clock signal GCK is generated based on the horizontal synchronization signal HSY. The charge share control signal Csh and the gate driver output control signals GOE (GOE1-GOEq) are generated based on the horizontal synchronization signal HSY and the control signal Dc.

Among the aforesaid signals generated by the display control circuit 200, the digital image signal DA, the charge share control signal Csh, the data start pulse signal SSP, and the data clock signal SCK are supplied to the source driver 300, whereas the gate start pulse signal GSP, the gate clock signal GCK, and the gate driver output control signals GOE are supplied to the gate driver 400.

Based on the digital image signal DA, the data start pulse signal SSP, and the data clock signal SCK, the source driver 300 serially generates, in each horizontal scanning period, data signals S(1)-S(n) as analog voltages equivalent to pixel values of the image represented by the digital image signal DA at the respective horizontal scanning lines. The source driver 300 then applies the data signals S(1)-S(n) to the respective source lines SL1-SLn. The source driver 300 adopts a dot inversion drive scheme which is a drive scheme in which the data signals S(1)-S(n) are output in such a way that the polarity of the voltage applied to the liquid crystal layer is inverted in each frame period and the voltage is also inverted, within each frame, in each gate line and each source line. Therefore the source driver 300 applies the voltages to the respective source lines SL1-SLn in such a way that neighboring source lines have inverted polarities, and inverts, in each horizontal scanning period, the voltage polarity of the data signal S(i) applied to each source line SLi. The electric potential which is the border between positive and negative polarities is a DC level (electric potential equivalent to a DC component) of each of the data signals S(1)-S(n). This DC level is typically different from the DC level of the common electrode Ec, by a feed through voltage ΔVd generated due to a parasitic capacity Cgd between the gate and drain of the TFT of each pixel formation section. When the feed through voltage ΔVd generated due to the parasitic capacity Cgd is sufficiently smaller than an optical threshold voltage Vth of liquid crystal, the DC levels of the data signals S(1)-S(n) are deemed to be equivalent to the DC level of the common electrode Ec. In this case, it is possible to consider that the polarities of the data signals S(1)-S(n), i.e. the polarities of the voltages applied to the source lines are inverted in each horizontal scanning period, with reference to the electric potential (opposing voltage) of the common electrode Ec.

In addition, this source driver 300 adopts a charge sharing scheme with which neighboring source lines are short-circuited when the polarity of each of the data signals S(1)-S(n) is inverted, in order to reduce the power consumption. For this reason, in the source driver 300 the output section from which the data signals S(1)-S(n) are output is arranged as shown in FIG. 6. This output section receives analog voltage signals d(1)-d(n) generated based on the digital image signal DA, and generates, by performing impedance conversion for the analog voltage signals d(1)-d(n), data signals S(1)-S(n) as video signal transmitted through the source lines SL1-SLn. As a voltage follower for the impedance conversion, the output section is provided with n output buffers 31. Grayscale reference voltages for the generation of the analog voltage signals d(1)-d(n) are voltages V0-Vp generated by the grayscale voltage source 600. The output terminals of the respective buffers 31 are connected to first MOS transistors SWa as switching elements. A data signal S(i) (i=1, 2, . . . , n) from each buffer 31 is output from the output terminal of the source driver 300 via the first MOS transistor SWa. Neighboring output terminals of the source driver 300 are connected to each other by a second MOS transistor SWb which is a switching element (with the result that neighboring source lines are connected with each other by a second MOS transistor SWb). The gate terminal of the second MOS transistor SWb between the output terminals receives a charge share control signal Csh. The gate terminal of the first MOS transistor SWa connected to the output terminal of each buffer 31 receives an output signal of the inverter 33, i.e. a signal generated by logically inverting the charge share control signal Csh.

The first MOS transistor SWa is turned on and the second MOS transistor SWb is turned off when the charge share control signal Csh is inactive (at low level). Therefore the data signal from each buffer 31 is output from the source driver 300 via the first MOS transistor SWa. On the other hand, the first MOS transistor SWa is turned off and the second MOS transistor SWb is turned on when the charge share control signal Csh is active (at high level). Therefore the data signal is not output from each buffer 31 (i.e. the application of the data signals S(1)-S(n) to the source lines SL1-SLn is blocked), and neighboring source lines in the display section 100 are short-circuited via the second MOS transistor SWb.

In the source driver 300, as shown in a in FIG. 3, an analog voltage signal d(i) is generated as a video signal whose polarity is inverted in one horizontal scanning period (1 H). In the meanwhile, the display control circuit 200 generates, as shown in b in FIG. 3, a charge share control signal Csh which is kept at high level (H level) for a predetermined period (a short period more or less equivalent to one horizontal blanking period) Tsh when the polarity of each analog voltage signal d(i) is inverted (hereinafter, the period in which the charge share control signal Csh is at H level is termed charge sharing period). As described above, the analog voltage signal d(i) is output as the data signal S(i) when the charge share control signal Csh is at low level (L level), whereas the application of the data signal S(1)-S(n) to the source lines SL1-SLn is blocked and neighboring source lines are short-circuited when the charge share control signal Csh is at H level. The present arrangement adopts the dot inversion drive scheme, and hence voltages of neighboring source lines are inverse to each other and have almost the same absolute values. Therefore the value of each data signal S(i), i.e. the voltage on each source line SLi is equivalent to a voltage for black display (hereinafter, this voltage will be simply referred to as black voltage), during the charge sharing period Tsh. In the present liquid crystal display apparatus, the polarity of each data signal S(i) is inversed with reference to the DC level SCdc of the data signal S(i). For this reason, as shown in c in FIG. 3, the data signal S(i) becomes almost equal to the DC level Vsdc of the data signal S(i), during the charge sharing period Tsh. This scheme in which the voltage of each source line is equalized with the black voltage (DC level VSdc of the data signal S(i)) by causing neighboring source lines to short-circuit at the time of polarity inversion of the data signal has conventionally been proposed as a measure for the reduction of power consumption (see Patent Documents 2 and 3, for example), and hence the scheme is not limited to the arrangement shown in FIG. 6.

To supply the data signals S(1)-S(n) to the respective pixel formation sections (to the pixel capacities thereof), the gate driver 400 serially selects, in each frame period (vertical scanning period) of the digital image signal DA, the gate lines GL1-GLm for about one horizontal scanning period for each line, and selects the gate line GLj (j=1 through m) for a predetermined period at the time of the polarity inversion of the data signal S(i), for the purpose of the below-mentioned black insertion. The selection of the gate lines GL1-GLm and the gate line GLj is carried out based on the gate start pulse signal GSP, the gate clock signal GCK, and the gate driver output control signal GOEr (r=1, 2, . . . , q). To put it differently, the gate driver 400 applies, to the respective gate lines GL1-GLm, scanning signals G(1)-G(m) each including a pixel data writing pulse Pw and a black voltage applying pulse Pb shown in d and e in FIG. 3. The gate line GLj to which the pulses Pw and Pb have been applied becomes in the selected state, and the TFT 10 connected to the gate line GLj in the selected state is turned on (the TFT 10 connected to the gate line in the non-selected state is turned off). At this point, in one horizontal scanning period (1 H) the pixel data writing pulse Pw is at H level in a valid scanning period corresponding to a display period, whereas in one horizontal scanning period (1 H) the black voltage applying pulse Pb is at H level in a charge sharing period Tsh which corresponds to a blanking period. In the present scheme, as shown in d and e in FIG. 3, each scanning signal G(j) is arranged such that an interval between a pixel data writing pulse Pw and the black voltage applying pulse Pb immediately after that pixel data writing pulse Pw is equivalent to ⅔ frame period, and the black voltage applying pulse Pb successively appears three times in one frame period (1V), at intervals of one horizontal scanning period (1 H).

Now, the following will discuss how the display section 100 (see FIG. 15) is driven by the source driver 300 and the gate drive 400, with reference to FIG. 3. In each pixel formation section of the display section 100, the gate line GLj connected to the gate terminal of the TFT 10 of the pixel formation section receives a pixel data writing pulse Pw so that the TFT 10 is turned on, with the result that the voltage on the source line SLi connected to the source terminal of that TFT 10 is, as a data signal S(i), written into the pixel formation section. In short, the voltage on the source line SLi is retained in the pixel capacity Cp. Thereafter, the gate line GLj is in the non-selected state during a period Thd until a black voltage applying pulse Pb appears. The voltage which has been written into the pixel formation section is therefore retained.

The black voltage applying pulse Pb is applied to the gate line GLj during a charge sharing period Tsh after the period of the non-selected state (this period will be referred to as pixel data retaining period hereinafter). As discussed above, in the charge sharing period Tsh the value of each data signal S(i), i.e. the voltage on each source line SLi is more or less equal to the DC level of the data signal S(i) (i.e. black voltage). Therefore, when the black voltage applying pulse Pb is applied to the gate line GLj, the voltage retained in the pixel capacity Cp of the pixel formation section starts to change towards the black voltage. However, because the pulse width of the black voltage applying pulse Pb is narrow, in each frame period three black voltage applying pulses Pb are successively applied to the gate line GLj at intervals of one horizontal scanning period (1 H) as shown in d and e in FIG. 3, in order to surely changes the voltage retained in the pixel capacity Cp to the black voltage. As a result the brightness L(j, i) (an amount of passing light determined by the voltage retained by the pixel capacity) of the pixel constituted by the pixel formation section connected to the gate line GLj changes as shown in f in FIG. 3.

Because of the above, in one display line corresponding to the pixel formation section connected to each gate line GLj, display based on the digital image signal DA is carried out in the pixel data retaining period Thd, and then black display is performed in a period Tbk after the application of the three black voltage applying pulses Pb until the next application of the pixel data writing pulse Pw to the gate line GLj. In this way the liquid crystal display apparatus performs impulse-type display thanks to the insertion of a period Tbk of black display (hereinafter, black display period Tbk) to each frame period.

As shown in d and e in FIG. 3, the moments at which pixel data writing pulses Pw appear are different between neighboring scanning signals G(j) by one horizontal scanning period (1 H). Therefore the moments at which the black voltage applying pulses Pb appear are also different between scanning signals G(j) by one horizontal scanning period (1 H). For this reason the black display period Tbk is shifted by one horizontal scanning period (1 H) in each display line, and hence the length of black insertion is identical for all display lines. In this way a sufficient black insertion period is obtained without reducing a period of charging the pixel capacity Cp for the writing of pixel data. Also, it is unnecessary to speed up the operation of the source driver 300 or the like for the sake of black insertion.

In the scheme for impulse-type display shown in FIG. 3, the voltage of each data signal has a value corresponding to black display, in a black signal insertion period at the time of the polarity inversion of the data signal. For the writing of a pixel value, each scanning signal line is in the selected state at least once in a black signal insertion period, after a predetermined pixel value retaining period elapses after the scanning signal line is selected in a valid scanning period. As a result a period of black display continues until the line becomes, for the next writing of a pixel value, in the selected state in the valid scanning period. With this, the length of black insertion is identical for all display lines. It is therefore possible to improve the display quality of a moving image by realizing impulse-type display by retaining a sufficient black insertion period, without reducing a period of charging the pixel capacity for the sake of writing of a pixel value.

However, such impulse-type display realized by black insertion is disadvantageous in that the gamma characteristic of display is deteriorated as compared to a case where impulse-type display is not adopted.

FIG. 16 shows gamma characteristic curves of display, of a case where impulse-type display by black insertion is not adopted (off-mode: full line) and of a case where impulse-type display by black insertion is adopted (on-mode: dotted line). Regarding the gamma characteristic curves, the horizontal axis indicates a value calculated by normalizing the grayscale of display data by the maximum grayscale, whereas the vertical axis indicates a brightness ratio calculated by normalizing actually-recognized display brightness by the maximum brightness. A typically display apparatus is arranged so as to have a gamma value of 2.2, and the gamma value in a normal hold mode (turn-off) without impulse-type display is set at this value. In this case, if the display type is switched to impulse-type (turn-on) from the state above, the gamma characteristic is changed to the side in which the gamma value (γ) is larger than 2.2. This gamma value of 2.2 is preferable because high display quality is achieved with it.

As such, when impulse-type display by black insertion is adopted, changes in brightness in accordance with grayscale changes of display data are unnatural as compared to a case where impulse-type display is not adopted, and hence the display quality is deteriorated.

The present invention was done to solve the problem above, and the objective of the present invention is to provide a display apparatus which can improve the gamma characteristic of display when impulse-type display by black insertion is performed, and a driving method of the display apparatus.

To achieve the objective above, the display apparatus of the present invention, which is an active matrix display apparatus performing display in such a way that voltages corresponding to display data are applied to pixels, the display apparatus being able to perform the display such that for each of the pixels black insertion is performed only during a predetermined period in one frame, is characterized by comprising gamma characteristic adjusting means for adjusting a gamma characteristic of the display when the display with the black insertion is performed.

According to this invention, the gamma characteristic adjusting means adjusts the gamma characteristic of display, when, for each pixel, display with black insertion is performed only in a predetermined period in one frame, i.e. when impulse-type display by black insertion is. This makes it possible to improve the gamma characteristic when display with black insertion is performed.

To achieve the objective above, the driving method of the display apparatus of the present invention, which is an active matrix display apparatus performing display in such a way that voltages corresponding to display data are applied to pixels, the display apparatus being able to perform display such that for each of the pixels black insertion is performed only during a predetermined period in one frame, is characterized in that a gamma characteristic of display is adjusted when display with the black insertion is performed.

According to this invention, the gamma characteristic of display is adjusted, when, for each pixel, display with black insertion is performed only in a predetermined period in one frame, i.e. when impulse-type display by black insertion is carried out. This makes it possible to improve the gamma characteristic when display with black insertion is performed.

As a result of the above, it is possible to realize a driving method of a display apparatus which can improve the gamma characteristic of display when impulse-type display by black insertion is performed.

As a result of the above, it is possible to realize a display apparatus which can improve the gamma characteristic of display when impulse-type display by black insertion is performed.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 relates to an embodiment of the present invention and is a block diagram showing a substantial part of a display apparatus.

FIG. 2 is a block diagram of a source driver of the display apparatus.

FIG. 3 is a timing chart showing the operation of the display apparatus when display with black insertion is performed.

FIG. 4 is a first graph for illustrating how a gamma characteristic is adjusted when display with black insertion is performed.

FIG. 5 is a second graph for illustrating how a gamma characteristic is adjusted when display with black insertion is performed and when such display is not performed.

FIG. 6 is a circuit diagram showing a first example of an output section of the source driver.

FIG. 7 is a circuit diagram showing a second example of the output section of the source driver.

FIG. 8 is a circuit diagram showing a third example of the output section of the source driver.

FIG. 9(a) is a block diagram of a gate driver of the display apparatus.

FIG. 9(b) is a block diagram of the gate driver of the display apparatus.

FIG. 10 is a timing chart showing the operation of the gate driver when display with black insertion is performed.

FIG. 11 relates to another embodiment of the present invention and is a block diagram showing a substantial part of a display apparatus.

FIG. 12 is a circuit block diagram showing an example of a grayscale voltage source of the display apparatus of FIG. 11.

FIG. 13 is a circuit diagram showing an example of a D/A converter section of the grayscale voltage source of FIG. 12.

FIG. 14 relates to a further embodiment of the present invention and is a block diagram showing a substantial part of a display apparatus.

FIG. 15 relates to a conventional art and is a block diagram showing a substantial part of a display apparatus.

FIG. 16 is a graph for illustrating a variation in a gamma characteristic when display with black insertion is performed.

### REFERENCE NUMERALS

11, 21 LIQUID CRYSTAL DISPLAY APPARATUS (DISPLAY APPARATUS)

250, 251, 252 DISPLAY CONTROL CIRCUIT (GAMMA CHARACTERISTIC ADJUSTING MEANS)

### BEST MODE FOR CARRYING OUT THE INVENTION

### Embodiment 1

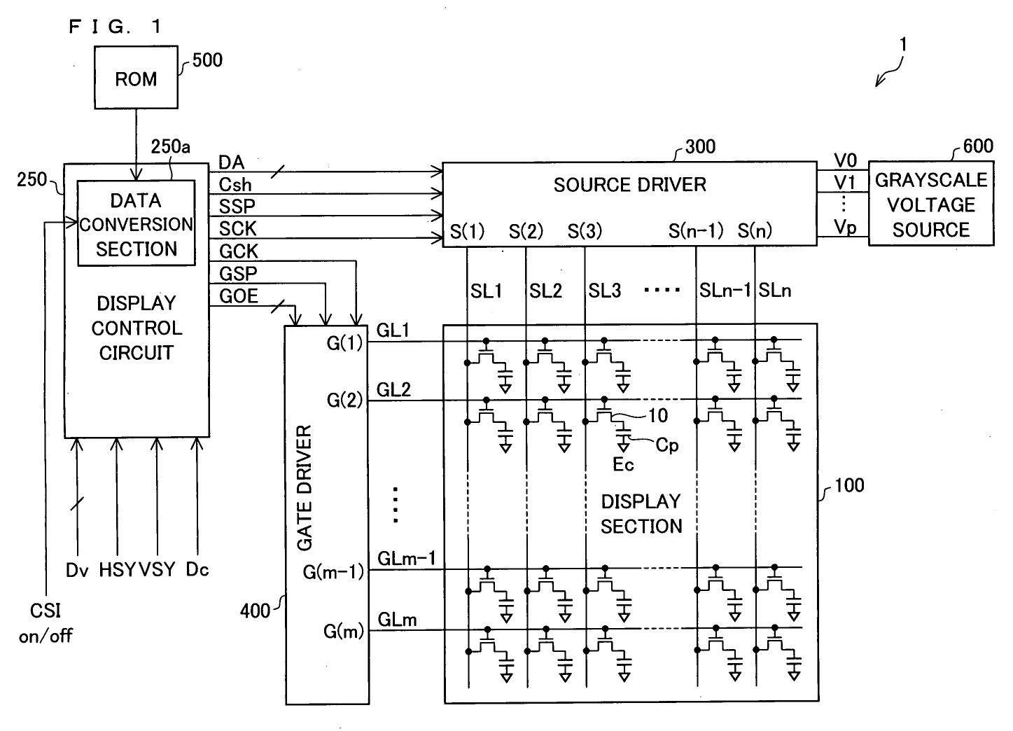

The following will describe an embodiment of the present invention with reference to FIGS. 1-10.

FIG. 1 is a block diagram showing a liquid crystal display apparatus 1 as a display apparatus of the present embodiment, together with an equivalent circuit of the display section. This liquid crystal display apparatus 1 includes: a source driver 300 as a data signal line drive circuit; a gate driver 400 as a scanning signal line drive circuit; an active-matrix display section 100; a display control circuit (gamma characteristic adjusting means) 250 for controlling the source driver 300 and the gate driver 400; a ROM 500; and a grayscale voltage source 600. Having these members, the liquid crystal display apparatus 1 can switch between a mode in which impulse-type display with black insertion is performed and a mode in which the impulse-type display is not performed, and can perform the selected mode. In the present embodiment, the present invention is described with the assumption that black is written in at the timing of a charge sharing period, e.g. when impulse-type display with black insertion is performed. However, charge sharing is not necessarily carried out, as long as impulse-type display is realized by black insertion. The inserted black is not necessarily a voltage corresponding to the minimum brightness, as long as a voltage corresponding to brightness within a predetermined range from the minimum brightness is eventually achieved. Hereinafter, impulse-type display realized by black insertion is simply termed as impulse-type display.

In the aforesaid liquid crystal display apparatus 1, the display section 100 includes: gate lines GL1-GLm which are plural (m) scanning signal lines; source lines SL1-SLn which are plural (n) data signal lines intersecting with the gate lines GL1-GLm, respectively; and plural (m×n) pixel formation sections provided at the respective intersections of the gate lines GL1-GLm and the source lines SL1-SLn. The pixel formation sections are disposed in a matrix manner so as to form a pixel array. Each pixel formation section is constituted by: a TFT 10 which is a switching element whose gate terminal is connected to the gate line GLj passing through the corresponding intersection and whose source terminal is connected to the source line SLi passing through the corresponding intersection; a pixel electrode connected to the drain terminal of the TFT 10; a common electrode Ec which is an opposing electrode shared by the pixel formation sections; and a liquid crystal layer which is shared by the pixel formation sections and is sandwiched between the pixel electrode and the common electrode Ec. A liquid crystal capacity formed by the pixel electrode and the common electrode Ec constitutes a pixel capacity Cp. To ensure the pixel capacity to hold a voltage, an auxiliary capacity may be provided in parallel to the liquid crystal capacity. This auxiliary capacity, however, is not described and is not shown in the figure.

The pixel electrode of each pixel formation section receives an electric potential corresponding to an image to be displayed, by means of the source driver 300 and the gate driver 400 which operate as discussed later. The common electrode Ec receives a predetermined electric potential Vcom from a power supply circuit which is not illustrated. As a result of this, a voltage corresponding to the potential difference between the pixel electrode and the common electrode Ec is applied to the liquid crystal, and an amount of light passing though the liquid crystal layer is controlled by the voltage application. An image is displayed in this way. For the control of an amount of passing light by the voltage application to the liquid crystal layer, polarizing plates are used. In the liquid crystal display apparatus 1 of the present embodiment, polarizing plates are provided so as to achieve normally black.

The display control circuit 250 receives, from an external signal source, a digital video signal Dv indicating an image to be displayed, a horizontal synchronization signal HSY and a vertical synchronization signal VSY which correspond to the digital video signal Dv, and a control signal Dc for controlling the display operation. Based on these signals Dv, HSY, VSY, and Dc, the display control circuit 250 generates and outputs, as signals for causing the display section 100 to display the image indicated by the digital video signal Dv, a data start pulse signal SSP, a data clock signal SCK, a charge share control signal Csh, a digital image signal DA (equivalent to the video signal Dv) representing the image to be displayed, a gate start pulse signal GSP, a gate clock signal GCK, and gate driver output control signals GOE.

After timing adjustment or the like is performed in an internal memory according to need, the video signal Dv is output from the display control circuit 250, as a digital image signal DA. The display control circuit 250 includes a data conversion section 250a. This data conversion section 250a outputs a digital image signal DA corresponding to the video signal Dv, based on information read out from a ROM 500 outside the display control circuit 250. The ROM 500 may be provided inside the display control circuit 250.

As an example, the following will discuss frame rate control by which a video signal Dv is converted into a digital image signal DA with higher definition in a pseudo way. In this frame rate control, assume that, for example, it is required to include, in display data, a grayscale having precision which cannot be reproduced by an 8-bit video signal Dv. In such a case, it is possible to render by 8-bit grayscale data a grayscale of a higher bits such as 10 bits in a pseudo way, by converting the 8-bit grayscale data row into a time-division data row within one frame by the data conversion section 250a. The ROM 500 stores in advance information of the time-division data row of the 8-bit digital image signal corresponding to the pseudo 10-bit digital image signal DA that the data conversion section 250 requires. Based on the information read out from the ROM 500, the data conversion section 250a outputs the 8-bit time-division data row after the conversion as the data row of the digital image signal DA.

The data clock signal SCK is generated as a signal by which the operation timing of a shift register in the source driver 300 is determined. The data start pulse signal SSP is generated as a signal which is changed based on the horizontal synchronization signal HSY to high level (H level) for a predetermined period of time in each horizontal scanning period, and is transferred in the shift register. The gate start pulse signal GSP is generated as a signal which is changed based on the vertical synchronization signal VSY to H level for a predetermined period time in each frame period (each vertical scanning period). The gate clock signal GCK is generated based on the horizontal synchronization signal HSY. The charge share control signal Csh and the gate driver output control signals GOE (GOE1-GOEq) are generated based on the horizontal synchronization signal HSY and the control signal Dc.

Among these signals generated by the display control circuit 250, the digital image signal DA, the charge share control signal Csh, the data start pulse signal SSP, and the data clock signal SCK are supplied to the source driver 300. The gate start pulse signal GSP, the gate clock signal GCK, and the gate driver output control signals GOE are supplied to the gate driver 400.

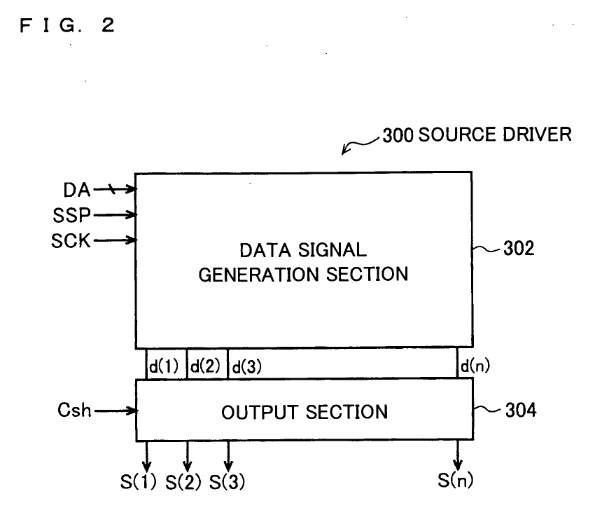

As shown in FIG. 2, the source driver 300 is constituted by a data signal generation section 302 and an output section 304. The data signal generation section 302 generates from the digital image signal DA analog voltage signals d(1)-d(n) corresponding to the respective source lines SL1-SLn, based on the data start pulse signal SSP and the data clock signal SCK. Grayscale reference voltages for the selection of the analog voltage signals d(1)-d(n) are voltages V0-Vp generated by the grayscale voltage source 600. The output section 304 includes analog buffers which are constituted by voltage followers provided for the respective analog voltage signals d(i) generated by the data signal generation section 302. By these buffers, impedance conversion for the analog voltage signals d(i) is carried out and the signals are output as data signals d(i) (i=1, 2, . . . , n). It is noted that, as discussed below, the application of the data signals S(1)-S(n) to the respective source lines SL1-SLn is blocked based on the charge share control signal Csh and the source lines SL1-SLn are short-circuited with one another, during the charge sharing period Tsh. The output section 304 includes a switching circuit and a power source, for the sake of achieving this operation (details will be given later).

The source driver 300 adopts a dot inversion drive scheme which is arranged such that data signals S(1)-S(n) are output so that the polarity of the voltage applied to the liquid crystal layer is inversed in each frame period and the polarity of the applied voltage is inverted each time a gate line is selected while adjacent source lines have inverse polarities in one frame. Therefore the source driver 300 arranges the polarities of the voltages on neighboring ones of the source lines SL1-SLn to be opposite to each other, and reverses the voltage polarity of the data signal S(i) applied to each source line SLi in each horizontal scanning period. The electric potential which is the border between positive and negative polarities is a DC level (electric potential corresponding to a DC component) of each of the data signals S(1)-S(n). This DC level is typically different from the DC level of the common electrode Ec, by a feed through voltage ΔVd which is generated by the parasitic capacity Cgd between the gate and drain of the TFT. When the feed through voltage ΔVd generated by the parasitic capacity Cgd is sufficiently lower than an optical threshold voltage Vth of the liquid crystal, it is deemed that the DC level of each of the data signals S(1)-S(n) is equal to the DC level of the common electrode Ec. In this case, it is possible to assume that the polarity of each of the data signals S(1)-S(n), i.e. the polarity of the voltage applied each source line is inverted in each horizontal scanning period, with reference to the electric potential (opposing voltage) of the common electrode Ec.

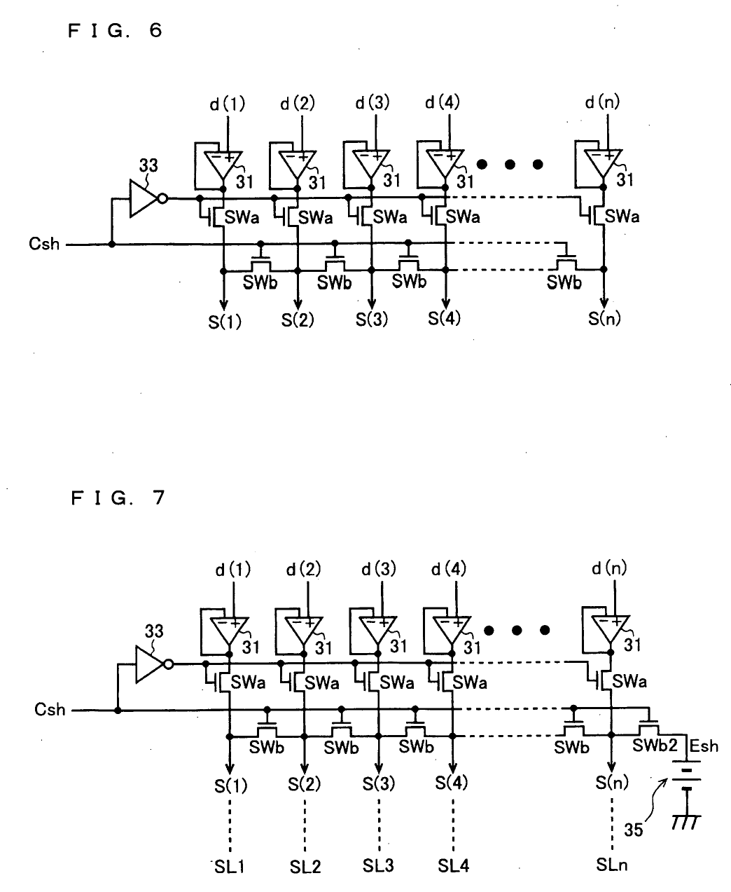

In addition, this source driver 300 adopts a charge sharing scheme with which neighboring source lines are short-circuited when the polarity of each of the data signals S(1)-S(n) is inverted, in order to reduce the power consumption. For this reason, in the source driver 300 the output section 304 is arranged as shown in FIG. 6. This output section receives analog voltage signals d(1)-d(n) generated based on the digital image signal DA, and generates, by performing impedance conversion for the analog voltage signals d(1)-d(n), data signals S(1)-S(n) as video signal transmitted through the source lines SL1-SLn. As a voltage follower for the impedance conversion, the output section is provided with n output buffers 31. The output terminals of the respective buffers 31 are connected to first MOS transistors SWa as switching elements. A data signal S(i) (i=1, 2, . . . , n) from each buffer 31 is output from the output terminal of the source driver 300 via the first MOS transistor SWa. Neighboring output terminals of the source driver 300 are connected to each other by a second MOS transistor SWb which is a switching element (with the result that neighboring source lines are connected with each other by a second MOS transistor SWb). The gate terminal of the second MOS transistor SWb between the output terminals receives a charge share control signal Csh. The gate terminal of the first MOS transistor SWa connected to the output terminal of each buffer 31 receives an output signal of the inverter 33, i.e. a signal generated by logically inverting the charge share control signal Csh.

The first MOS transistor SWa is turned on and the second MOS transistor SWb is turned off when the charge share control signal Csh is inactive (at low level). Therefore the data signal from each buffer 31 is output from the source driver 300 via the first MOS transistor SWa. On the other hand, the first MOS transistor SWa is turned off and the second MOS transistor SWb is turned on when the charge share control signal Csh is active (at high level). Therefore the data signal is not output from each buffer 31 (i.e. the application of the data signals S(1)-S(n) to the source lines SL1-SLn is blocked), and neighboring source lines in the display section 100 are short-circuited via the second MOS transistor SWb.

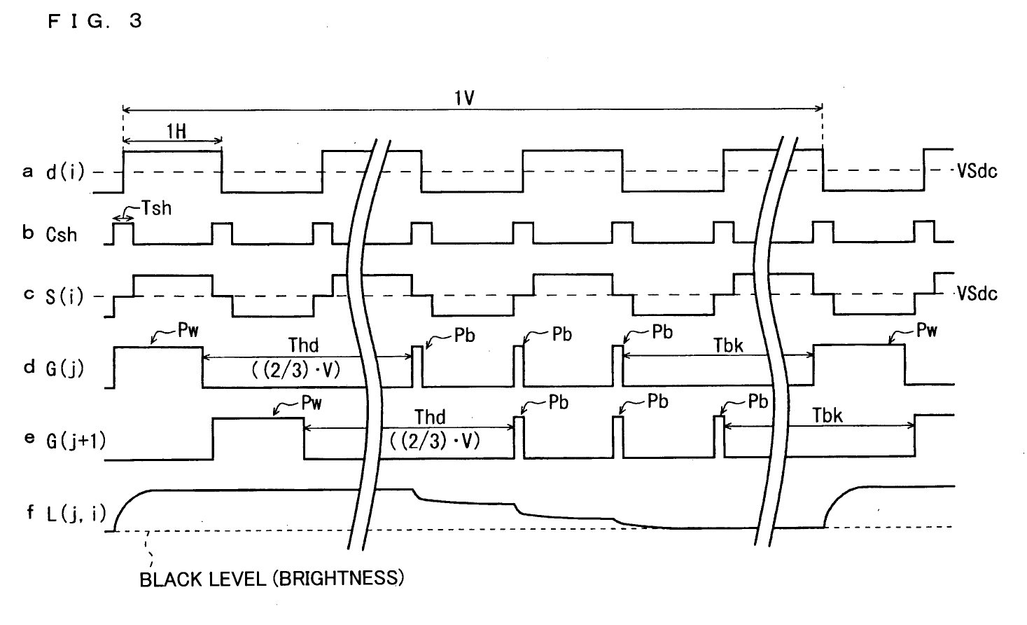

In the source driver 300, as shown in a in FIG. 3, an analog voltage signal d(i) is generated as a video signal whose polarity is inverted in one horizontal scanning period (1 H). In the meanwhile, the display control circuit 250 generates, as shown in b in FIG. 3, a charge share control signal Csh which is kept at high level (H level) for a predetermined period (a short period more or less equivalent to one horizontal blanking period) Tsh when the polarity of each analog voltage signal d(i) is inverted (hereinafter, the period in which the charge share control signal Csh is at H level is termed charge sharing period). As described above, the analog voltage signal d(i) is output as the data signal S(i) when the charge share control signal Csh is at low level (L level), whereas the application of the data signal S(1)-S(n) to the source lines SL1-SLn is blocked and neighboring source lines are short-circuited when the charge share control signal Csh is at H level. The present arrangement adopts the dot inversion drive scheme, and hence voltages of neighboring source lines are inverse to each other and have almost the same absolute values. Therefore the value of each data signal S(i), i.e. the voltage on each source line SLi is equivalent to a voltage for black display (hereinafter, this voltage will be simply referred to as black voltage), during the charge sharing period Tsh. In the present liquid crystal display apparatus, the polarity of each data signal S(i) is inversed with reference to the DC level SCdc of the data signal S(i). For this reason, as shown in c in FIG. 3, the data signal S(i) becomes almost equal to the DC level Vsdc of the data signal S(i), during the charge sharing period Tsh. This scheme in which the voltage of each source line is equalized with the black voltage (DC level VSdc of the data signal S(i)) by causing neighboring source lines to short-circuit at the time of polarity inversion of the data signal has conventionally been proposed as a measure for the reduction of power consumption (see Patent Documents 2 and 3, for example), and hence the scheme is not limited to the arrangement shown in FIG. 6.

To supply the data signals S(1)-S(n) to the respective pixel formation sections (to the pixel capacities thereof), the gate driver 400 serially selects, in each frame period (vertical scanning period) of the digital image signal DA, the gate lines GL1-GLm for about one horizontal scanning period for each line, and selects the gate line GLj (j=1 through m) for a predetermined period at the time of the polarity inversion of the data signal S(i), for the purpose of the below-mentioned black insertion. The selection of the gate lines GL1-GLm and the gate line GLj is carried out based on the gate start pulse signal GSP, the gate clock signal GCK, and the gate driver output control signal GOEr (r=1, 2, . . . , q). To put it differently, the gate driver 400 applies, to the respective gate lines GL1-GLm, scanning signals G(1)-G(m) each including a pixel data writing pulse Pw and a black voltage applying pulse Pb shown in d and e in FIG. 3. The gate line GLj to which the pulses Pw and Pb have been applied becomes in the selected state, and the TFT 10 connected to the gate line GLj in the selected state is turned on (the TFT 10 connected to the gate line in the non-selected state is turned off). At this point, in one horizontal scanning period (1 H) the pixel data writing pulse Pw is at H level in a valid scanning period corresponding to a display period, whereas in one horizontal scanning period (1 H) the black voltage applying pulse Pb is at H level in a charge sharing period Tsh which corresponds to a blanking period. In the present scheme, as shown in d and e in FIG. 3, each scanning signal G(j) is arranged such that an interval between a pixel data writing pulse Pw and the black voltage applying pulse Pb immediately after that pixel data writing pulse Pw is equivalent to ⅔ frame period, and the black voltage applying pulse Pb successively appears three times in one frame period (1V), at intervals of one horizontal scanning period (1 H).

Details of the gate driver 400 will be given later.

Now, the following will discuss how the display section 100 (see FIG. 1) is driven by the source driver 300 and the gate drive 400, with reference to FIG. 3. In each pixel formation section of the display section 100, the gate line GLj connected to the gate terminal of the TFT 10 of the pixel formation section receives a pixel data writing pulse Pw so that the TFT 10 is turned on, with the result that the voltage on the source line SLi connected to the source terminal of that TFT 10 is, as a data signal S(i), written into the pixel formation section. In short, the voltage on the source line SLi is retained in the pixel capacity Cp. Thereafter, the gate line GLj is in the non-selected state during a period Thd until a black voltage applying pulse Pb appears. The voltage which has been written into the pixel formation section is therefore retained.

The black voltage applying pulse Pb is applied to the gate line GLj during a charge sharing period Tsh after the period of the non-selected state (this period will be referred to as pixel data retaining period hereinafter). As discussed above, in the charge sharing period Tsh the value of each data signal S(i), i.e. the voltage on each source line SLi is more or less equal to the DC level of the data signal S(i) (i.e. black voltage). Therefore, when the black voltage applying pulse Pb is applied to the gate line GLj, the voltage retained in the pixel capacity Cp of the pixel formation section starts to change towards the black voltage. However, because the pulse width of the black voltage applying pulse Pb is narrow, in each frame period three black voltage applying pulses Pb are successively applied to the gate line GLj at intervals of one horizontal scanning period (1 H) as shown in d and e in FIG. 3, in order to surely changes the voltage retained in the pixel capacity Cp to the black voltage. As a result the brightness L(j, i) (an amount of passing light determined by the voltage retained by the pixel capacity) of the pixel constituted by the pixel formation section connected to the gate line GLj changes as shown in f in FIG. 3.

Because of the above, in one display line corresponding to the pixel formation section connected to each gate line GLj, display based on the digital image signal DA is carried out in the pixel data retaining period Thd, and then black display is performed in a period Tbk after the application of the three black voltage applying pulses Pb to the next application of the pixel data writing pulse Pw to the gate line GLj. In this way the liquid crystal display apparatus 1 performs impulse-type display thanks to the insertion of a period Tbk of black display (hereinafter, black display period Tbk) to each frame period.

As shown in d and e in FIG. 3, the moments at which pixel data writing pulses Pw appear are different between neighboring scanning signals G(j) by one horizontal scanning period (1 H). Therefore the moments at which the black voltage applying pulses Pb appear are also different between scanning signals G(j) by one horizontal scanning period (1 H). For this reason the black display period Tbk is shifted by one horizontal scanning period (1 H) in each display line, and hence the length of black insertion is identical for all display lines. In this way a sufficient black insertion period is obtained without reducing a period of charging the pixel capacity Cp for the writing of pixel data. Also, it is unnecessary to speed up the operation of the source driver 300 or the like for the sake of black insertion.

In the aforesaid liquid crystal display apparatus 1, the data conversion section 250a of the display control circuit 250 differentiates, between the mode in which impulse-type display is performed and the mode in which the impulse-type display is not performed, the information of the digital image signal DA, which is read out from the ROM 500 in accordance with the video signal Dv. The switching of the mode is, as shown in FIG. 1, carried out based on the turn-on/off of the control signal CSI which is supplied from the outside of the display control circuit 250 to the data conversion section 250a and which controls the turn-on/off of the impulse-type display. In the mode in which impulse-type display is performed, in order to adjust the gamma characteristic of the display, information of a data row which is stored in the ROM 500 in advance and which corresponds to the gamma characteristic for the mode in which impulse-type display is performed is read out, and the pseudo-multi-bit video signal Dv is converted into the digital image signal DA. In the mode in which impulse-type display is not performed, information of a data row which is stored in the ROM 500 in advance and which corresponds to the gamma characteristic for the mode in which impulse-type display is not performed is read out, and the pseudo-multi-bit video signal Dv is converted into the digital image signal DA.

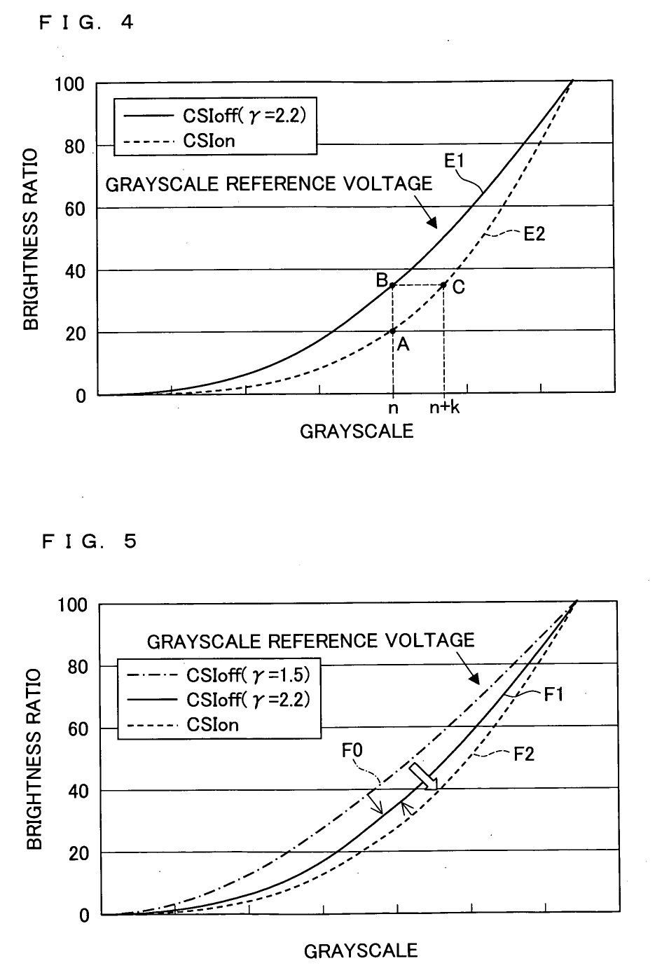

FIG. 4 is provided for illustrating a first example of the aforesaid adjustment of the gamma characteristic.

In FIG. 4, the horizontal axis indicate a value generated by normalizing a grayscale of display data by the maximum grayscale, whereas the vertical axis indicates a brightness ratio generated by normalizing actually-perceived display brightness by the maximum brightness. The gamma characteristic curve E1 indicated by the full line indicates the characteristic in the mode in which impulse-type display is not performed (off-mode), and the gamma value (γ) in this case is 2.2. The gamma characteristic curve E2 indicated by the dotted line indicates the characteristic in the mode in which impulse-type display is performed (on-mode), and the gamma value (γ) in this case is higher than 2.2. Both of these curves are obtained when a voltage corresponding to each grayscale is set at a grayscale reference voltage of the grayscale voltage source 600. In the present embodiment, in the mode in which impulse-type display is performed, a varying gamma characteristic is adjusted so that the gamma characteristic curve E2 conforms to the gamma characteristic curve E1.

For conducting the adjustment to cause the gamma characteristic curve to conform to the gamma characteristic curve E1, the data conversion section 250a sends to the ROM 500 information indicating the mode in which impulse-type display is performed and information of a pseudo-10-bit data row. It is desired, in FIG. 4, the brightness ratio at a point A corresponding to a grayscale n on the gamma characteristic curve E2 is converted into the brightness ratio at a point B corresponding to a grayscale n on the gamma characteristic curve E1. Therefore the ROM 500 regards a request from the data conversion section 250a to read out data corresponding to a grayscale n (normalized grayscale) at a point A on the gamma characteristic curve E2 as a request to read out a grayscale n+k (normalized grayscale) at a point C on the gamma characteristic curve E2, at which the same brightness ratio as the point B on the gamma characteristic curve E1 is obtained. In this way, the ROM 500 returns, to the data conversion section 250a, information of an 8-bit time-division data row corresponding to the pseudo-10-bit data row. In the meanwhile, in the mode in which impulse-type display is not performed, as information of a data row that the data conversion section 250a requests to read out, the ROM 500 returns to the data conversion section 250a information of an 8-bit time-division data row of the gamma characteristic curve E1, which corresponds to the pseudo-10-bit data row.

Now, a second example of the adjustment of the gamma characteristic will be discussed with reference to FIG. 5.

In the mode in which impulse-type display is performed, as indicated by the bold arrow in FIG. 5, a varying gamma characteristic may not be adjusted to conform to the curve of the gamma characteristic 2.2, when a variation of the gamma characteristic is too severe at the time of switching of the mode from the mode in which impulse-type display is not performed. In such a case, as shown in FIG. 5, the gamma characteristic is not adjusted in the mode in which impulse-type display is not performed, and a gamma characteristic curve F0 obtained when a voltage corresponding to each grayscale is set at a reference voltage is arranged to be smaller than 2.2, e.g. a gamma value of 1.5. Also, in the mode in which impulse-type display is not performed, the gamma characteristic curve F0 is adjusted to conform to the gamma characteristic curve F1 with the gamma value of 2.2. This makes reduces a difference in the gamma values between the gamma characteristic curve F2 which varies in the mode in which impulse-type display is performed and the gamma characteristic curve F1 with the gamma value of 2.2, thereby making it easy to perform the adjustment by which the gamma characteristic curve F2 is arranged to conform to the gamma characteristic curve F1. The adjustment of the gamma characteristic curves F0 and F2 is carried out in the same manner as the first example.

In the first example, the gamma characteristic of the gamma characteristic curve E2 is independently adjusted. On the other hand, in the second example the gamma characteristic of the gamma characteristic curve F0 and the gamma characteristic of the gamma characteristic curve F2 are independently adjusted. In this way, in the second example, two gamma characteristic curves are, as indicated by a narrow arrow in FIG. 5, adjusted so that the curves conform to one another at a target gamma characteristic between the curves.

As discussed above, in the present embodiment, as illustrated in the first and second examples of the adjustment of the gamma characteristic, the gamma characteristic of the display is adjusted by the display control circuit 250 when, for each pixel, black insertion is performed for a predetermined period of time in one frame by a voltage applied in a predetermined horizontal blanking period, i.e. when impulse-type display is realized by black insertion. In doing so, the display control circuit 250 adjusts the gamma characteristic of the display by adjusting the display data in periods other than the aforesaid predetermined period. It is therefore possible to easily adjust the gamma characteristic, and hence the gamma characteristic in the case of display with black insertion is improved.

As a result of the above, it is possible to realized a display apparatus in which the gamma characteristic of the display is improved when impulse-type display by black insertion is performed.

In the first example, the gamma characteristic is adjusted so that the gamma characteristic in the case of display with black insertion is arranged to conform to the gamma characteristic in the case of display without black insertion. Therefore the gamma characteristic in the case of display with black insertion is good in the same manner as the gamma characteristic in the case of display without black insertion.

In the second example, the display control circuit 250 adjusts the gamma characteristic of display for respective cases of (i) display in which black insertion is carried out for each pixel for a predetermined period of time in one frame by a voltage applied in a predetermined horizontal blanking period, i.e. impulse-type display realized by black insertion, and (ii) display without black insertion. In doing so, the display control circuit 250 adjusts the gamma characteristic of display by adjusting display data when display without black insertion is carried out, and adjusts the gamma characteristic of display by adjusting display data of periods other than the aforesaid predetermined period when display with black insertion is carried out. It is therefore possible to easily adjust the gamma characteristic. This makes it possible to improve the gamma characteristic when display with black insertion is carried out.

In the second example, when it is difficult to adjust the gamma characteristic when display with black insertion is performed to be close to the gamma characteristic when display without black insertion is performed, the gamma characteristic when display without black insertion is performed is arranged to be different from a desired gamma characteristic in advance, taking advantage of the nature that the gamma characteristic when display with black insertion is performed is different from the gamma characteristic when display without black insertion is performed. This makes it easily to arrange the gamma characteristics to be close to a desired gamma characteristic by adjusting both the gamma characteristic when display with black insertion is performed and the gamma characteristic when display without black insertion is performed.

As a result of the above, it is possible to realize a display apparatus which can improve the gamma characteristic of display when impulse-type display is realized by black insertion.

In the second example, the result of the adjustment of the gamma characteristic when display without black insertion is performed is arranged to conform to the result of the adjustment of the gamma characteristic when display with black insertion is performed. Therefore the gamma characteristic in the case of display with black insertion is good in the same manner as the gamma characteristic in the case of display without black insertion.

Further explanation of the source driver 300 will be given below.

The first example of the output section 304 of the source driver 300 has been given in FIG. 6. FIG. 7 is a circuit diagram showing a second example of the output section 304 of the source driver 300 of the present embodiment. The output section 304 of this example includes inverters 33 and switching circuits constituted by n first MOS transistors SWa and (n−1) second MOS transistors SWb which are switching elements. in terms of this arrangement, this output section is identical with the output buffer of the source driver 300 of the first example. Being different from the output section of the source driver 300 of the first example, the output section 304 of the second example includes a charge share voltage fixing power source 35. The positive terminal of this charge share voltage fixing power source 35 is connected, via a third MOS transistor SWb2 which is a switching element, to the output terminal of the source driver to be connected to one of the source lines SL(i). (In the example shown in FIG. 7, the positive terminal is connected to the output terminal to be connected to the n-th source line SLn.) The gate terminal of the third MOS transistor SWb2 receives a charge share control signal Csh, and the negative terminal of the charge share voltage fixing power source 35 is grounded. This charge share voltage fixing power source 35 is a voltage supply section which provides a fixed voltage Esh equivalent to black display. This voltage Esh falls within a voltage range from the value of a negative data signal S(i) of 0 grayscale to the value of a positive data signal S(i) of 0 grayscale. The voltage Esh is applied to the pixel electrode by the black voltage applying pulse Pb during the charge sharing period Tsh (see FIG. 3). The voltage on the pixel electrode (i.e. pixel voltage) decreases by the value of the feed through voltage ΔVd at the time of the rise of the black voltage applying pulse, on account of the presence of the parasitic capacity Cgd. In regard to the power source voltage Esh, it is therefore necessary to take account of the compensation of the feed through voltage ΔVd, and hence the pixel voltage does not always become equivalent to the voltage corresponding to black display, even if the power source voltage Esh is arranged to be close to the opposing voltage.

In the aforesaid second example, based on the charge share control signal Cs, during the periods other than the charge sharing period Tsh (i.e. valid scanning period other than the charge sharing period) the analog voltage signals d(1)-d(n) generated by the data signal generation section 302 are output as the data signals S(1)-S(n) via the buffers 31 and applied to the source lines SL1-SLn. During the charge sharing period Tsh, the application of the data signals S(1)-S(n) to the source lines SL1-SLn is blocked and neighboring source lines short-circuit each other (with the result that all of the source lines SL1-SLn short-circuit one another). In addition, in the second example, during the charge sharing period Tsh each source line SLi (i=1−n) receives the voltage Esh of the charge share voltage fixing power source 35 (see FIG. 7).

However, in the first example, as shown in FIG. 7, many source lines are connected to the charge share voltage fixing power source 35 via plural MOS transistors SWb. For this reason it takes time to arrange all of the source lines SL1-SLn to have the same charge share voltage Esh. Because of this, the length of the charge sharing period Tsh may not allow the black voltages stored in the pixel capacities of the respective pixel formation sections to be the same on the occasion of black insertion, and hence the reflection of the corresponding pattern may not be sufficiently restrained.

Now, as a third example, the following will discuss the output section of the source driver by which all of the source lines SL1-SLn are arranged to have the same voltage Esh in a short period of time during the charge sharing period Tsh.

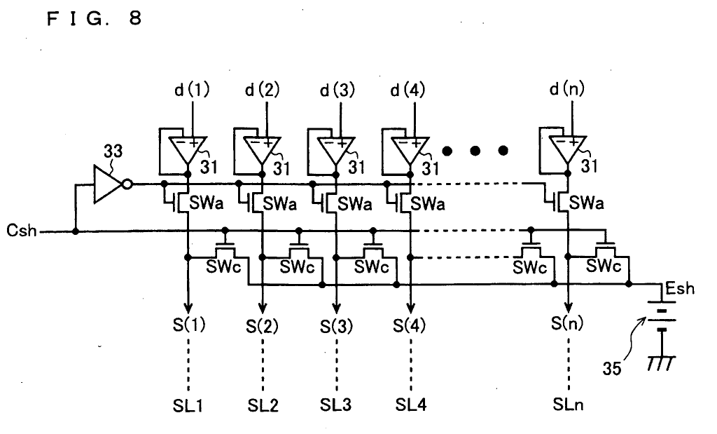

FIG. 8 is a circuit diagram showing a third example of the output section 304 of the source driver 300. By the way, members of the output section 304 having the same functions as those described in the second example are given the same numbers, so that the descriptions are omitted for the sake of convenience.

Being similar to the second example, the output section 304 of the present example is arranged such that one second MOS transistor SWc as a switching element is provided for each source line SLi (i=1−n). However, while the second example is arranged so that in a switching circuit one second MOS transistor SWb is interposed between neighboring source lines, the present example is arranged so that in a switching circuit one second MOS transistor SWc is interposed between each source line SLi and the charge share voltage fixing power source 35. In other words, in the present example, the output terminal of the source drive to be connected to each source line SLi is connected to the positive terminal of the charge share voltage fixing power source 35 via one of the second MOS transistors SWc. All of the gate terminals of these second MOS transistors SWc receive the charge share control signal Csh.

In the aforesaid third example, based on the charge share control signal Csh, during the periods other than the charge sharing period Tsh (i.e. a valid scanning period other than the charge sharing period) the analog voltage signals d(1)-d(n) generated by the data signal generation section 302 are output as the data signals S(1)-S(n) via the buffers 31 and applied to the source lines SL1-SLn. During the charge sharing period Tsh, the application of the data signals S(1)-S(n) to the source lines SL1-SLn is blocked and neighboring source lines short-circuit each other (with the result that all source lines SL1-SLn short-circuit one another). In addition, in the third example, during the charge sharing period Tsh the source lines SLi (i=1−n) receive the voltage Esh of the charge share voltage fixing power source 35 (see FIG. 8).

The following will describe the gate driver 400 of the present embodiment.

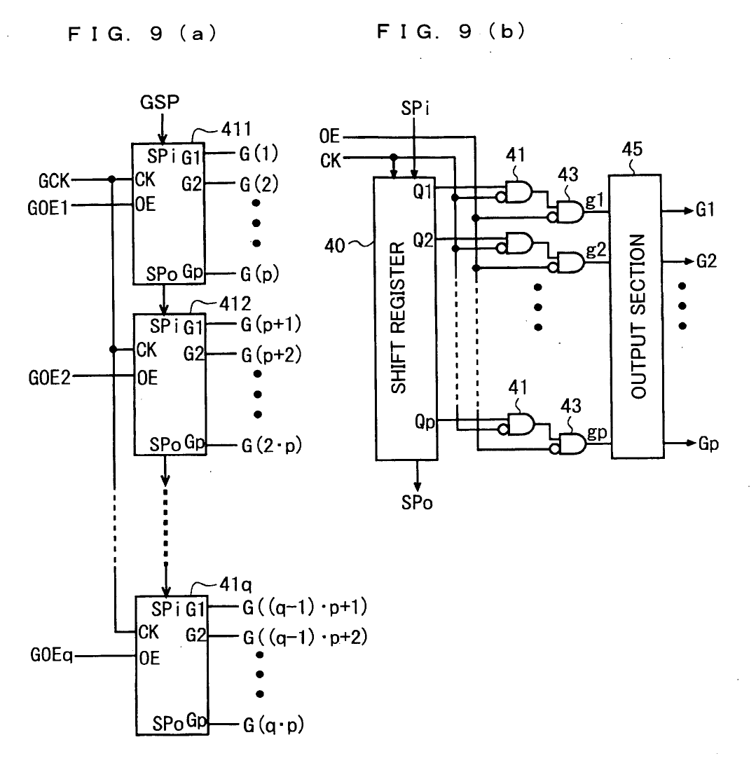

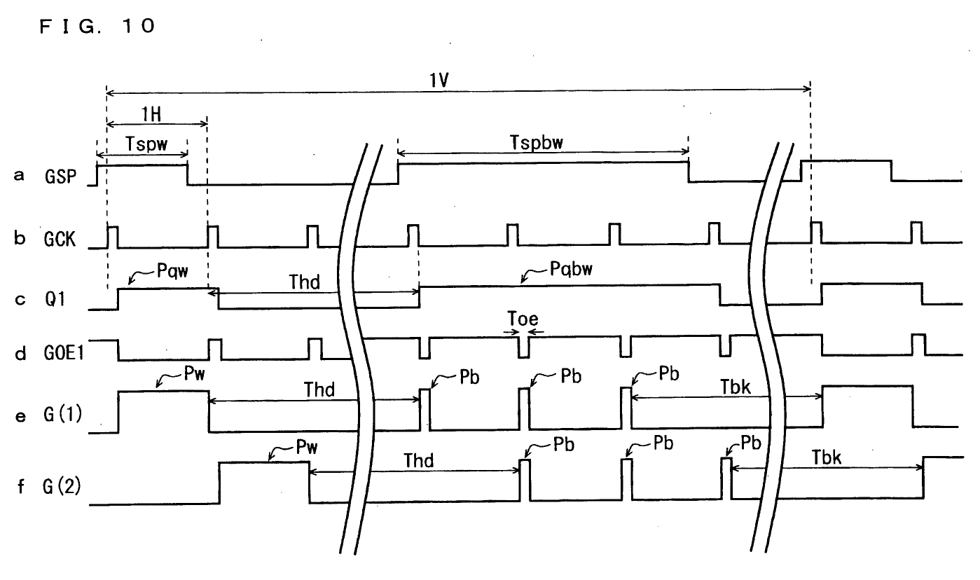

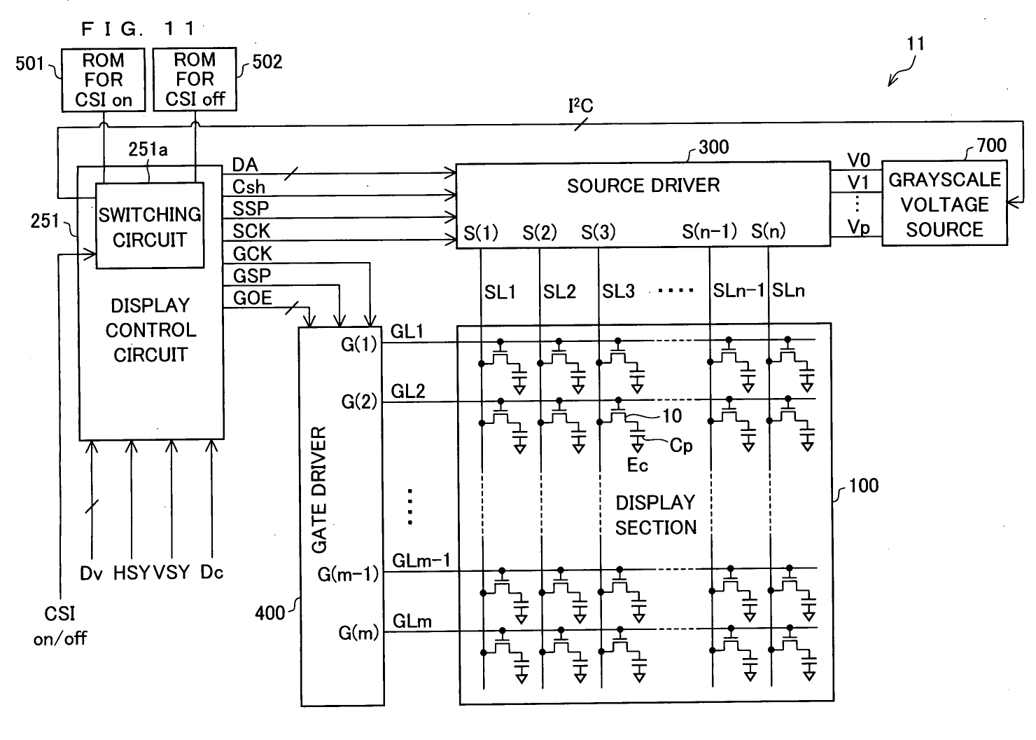

FIG. 9(a) and FIG. 9(b) are block diagrams showing an example of the gate driver 400 which operates as shown in d and e in FIG. 3. The gate driver 400 of the present example is constituted by gate drive IC (Integrated Circuit) chips 41l, 412, . . . , 41q which are q partial circuits including shift registers.

As shown in FIG. 9(b), each gate driver IC chip includes a shift register 40, first and second AND gates 41 and 43 provided to correspond to the respective stages of the shift register 40, and an output section 45 which outputs scanning signals G1-Gp based on output signals g1-gp of the second AND gate 43, and the gate driver IC chip receives, from the outside, a start pulse signal SPi, a clock signal CK, and an output control signal OE. The start pulse signal SPi is supplied to the input terminal of the shift register 40, and the output terminal of the shift register 40 outputs a start pulse signal SPo to be supplied to the gate driver IC chip on the subsequent stage. Each of the first AND gate 41 receives a signal generated by logically inverting the clock signal CK. Each of the second AND gate 43 receives a signal generated by logically inverting the output control signal OE. The output signals Wk (k=1−p) of the respective stages of the shift register 40 are supplied to the first AND gates 41 corresponding to the respective stages. The output signals of the first AND gates 41 are supplied to the second AND gates 43 corresponding to the respective stages.

As shown in FIG. 9(a), the gate driver 400 of the present example is realized by cascading q gate driver IC chips 41l-41q arranged as above. That is to say, the output terminal (from which the start pulse signal SPo is output) of the shift register in each gate driver IC chip is connected to the input terminal (to which the start pulse signal SPi is input) of the shift register in the subsequent gate driver IC chip, in such a way that the shift registers 40 in the respective gate driver IC chips 41l-41q form a single shift register (hereinafter, such a shift register formed by the cascade connection will be referred to as combined shift register). It is noted that the input terminal of the shift register in the first gate driver IC chip 41l receives the gate start pulse signal GSP from the display control circuit 250, and the output terminal of the shift register in the last gate driver IC chip 41q is not connected to the outside. The gate clock signal GCK from the display control circuit 250 is commonly supplied to the gate driver IC chips 41l-41q, as the clock signal CK. In the meanwhile, the gate driver output control signals GOE generated by the display control circuit 250 are constituted by first to q-th gate driver output control signals GOE1-GOEq, and these gate driver output control signals GOE1-GOEq are independently supplied to the respective gate driver IC chips 41l-41q, as the output control signals OE.

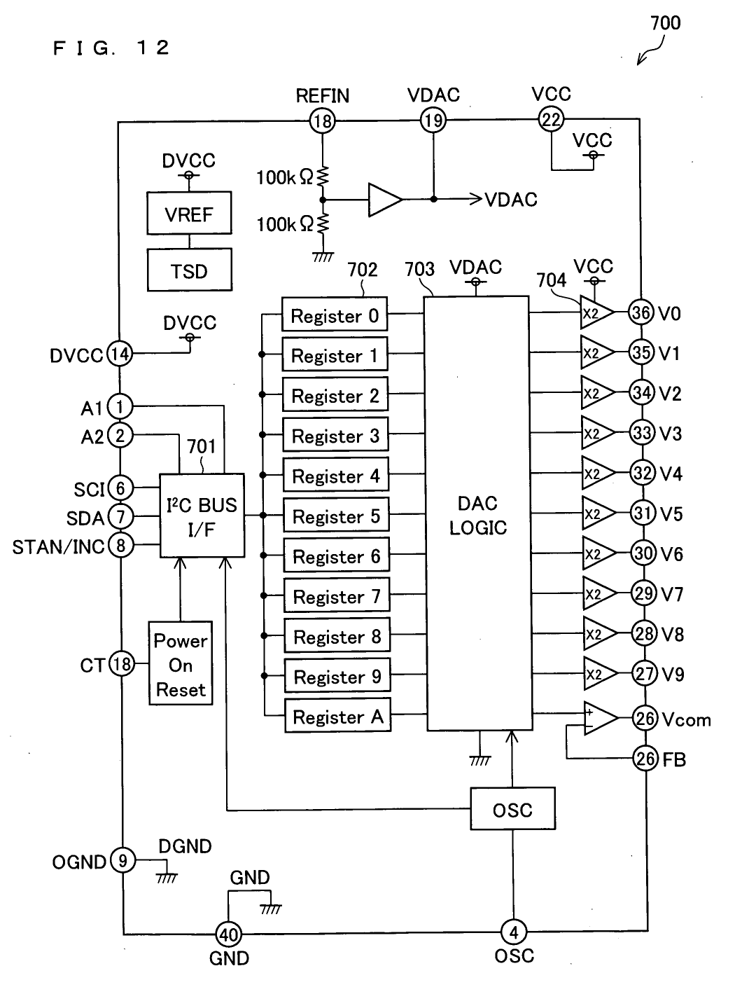

Now, the following will discuss how the aforesaid gate driver 400 operates, with reference to FIG. 10. As shown in a in FIG. 10, the display control circuit 250 generates, as a gate start pulse signal GSP, a signal which is at H level (turns to be active) only during a period Tspw corresponding to the pixel data writing pulse Pw and a period Tspbw corresponding to three black voltage applying pulses Pb, and, as shown in b in FIG. 10, generates a gate clock signal GCK which is at H level only during a predetermined period of time in each horizontal scanning period (1 H). When such a gate start pulse signal GSP and a gate clock signal GCK are supplied to the gate driver 400 shown in FIG. 9(a) and FIG. 9(b), a signal shown in c in FIG. 10 is output as an output signal Q1 of the first-stage shift register 40 of the first gate driver IC chip 41l. In each frame period this output signal Q1 includes one pulse Pqw corresponding to the pixel data writing pulse Pw and one pulse Pqbw corresponding to three black voltage applying pulses Pb. These pulses Pqw and Pqbw are distanced by about a pixel data retaining period Thd. Such two pulses Pqw and Pqbw are serially transferred in the combined shift register in the gate driver 400, in accordance with the gate clock signal GCK. In response to this, the respective stages of the combined shift register output signals with the waveform indicated in c in FIG. 10. These signals are output in such a way that successive signals are deviated from one another by one horizontal scanning period (1 H).

As discussed above, the display control circuit 250 generates the gate driver output control signals GOE1-GOEq which are supplied to the gate driver IC chips 41l-41q constituting the gate driver 400. During a period in which the pulse Pqw corresponding to the pixel data writing pulse Pw is output from any one of the stages of the shifter register 40 in the gate driver IC chip 41r, the gate driver output control signal GOEr supplied to the r-th gate driver IC chip 41r is at L level except that the signal is at H level during a predetermined period of time around each pulse of the gate clock signal GCK. During periods other than the above, the gate driver output control signal GOEr is H level except that the signal is at L level during a predetermined period Toe (which is arranged to be included in the charge sharing period Tsh) immediately after the gate clock signal GCK changes from H level to L level. For example, the first gate driver IC chip 41l receives the gate driver output control signal GOE1 shown in d in FIG. 10. The pulse which is included in each of the gate driver output control signals GOE1-GOEq for the adjustment of the pixel data writing pulse Pw (this pulse is equivalent to a change to H level in the aforesaid predetermined period and will be referred to writing period adjusting pulse rises before the rise of the gate clock signal GCK or rises after the rise of the gate clock signal GCK, in accordance with the necessary pixel data writing pulse Pw. The pixel data writing pulse Pw may be adjusted only by the pulse of the gate clock signal GCK, without using the aforesaid writing period adjusting pulse.

In each of the gate driver IC chips 41r (r=1−q), based on the aforesaid output signals Qk (k=1−p) of the respective stages of the shift register 40, the gate clock signal GCK, and the gate driver output control signal GOEr, the first and second AND gates 41 and 43 generate internal scanning signals g1-gp, and these internal scanning signal g1-gp are subjected to level conversion in the output section 45 so that the scanning signals G1-Gp to be applied to the gate lines are output. As a result, as shown in e and f in FIG. 10, the gate lines GL1-GLm serially receive the pixel data writing pulse Pw, and the gate lines GLj (j=1−m) receive the black voltage applying pulse Pb at a timing when the pixel data retaining period Thd elapses from the application of the pixel data writing pulse. Thereafter the gate lines GLj (j=1−m) receive two black voltage applying pulses Pb at intervals of one horizontal scanning period (1 H). After three black voltage applying pulses Pb are applied in this manner, the gate lines are kept at L level until the pixel data writing pulse of the next frame period is applied. In other words, a period from the application of three black voltage applying pulses Pb to the application of the next pixel data writing pulse Pw is a black display period Tbk.

In the manner as above, the gate driver 400 shown in FIG. 9(a) and FIG. 9(b) achieves impulse-type display shown in c-f in FIG. 3 in the liquid crystal display apparatus 1.

In impulse-type display of the present embodiment, in each charge sharing period Tsh at the time of the polarity inversion of the data signal S(i) the voltage on each source line SLi has a value corresponding to black display (see c in FIG. 3), and each gate line GLj receives three black voltage applying pulses Pb at intervals of one horizontal scanning period within a charge sharing period Tsh (see d and e in FIG. 3), after a pixel data retaining period Thd which is equivalent to ⅔ of one frame period elapses after the application of the pixel data writing pulse Pw. As a result, a black display period Tbk continues until the application of the next pixel data writing pulse Pw, and hence black insertion about ⅓ frame is carried out in each frame. That is to say, black insertion of the same length is carried out for all display lines in such a way that a black display period Tbk for impulse-type display is deviated by one horizontal scanning line (1 H) between neighboring display lines (see d and e in FIG. 3). This makes it possible to secure a sufficient black insertion period without reducing time to charge the pixel capacity Cp for the sake of writing of image data, and it is unnecessary to increase the operation speed of the source driver 300 or the like for the purpose of black insertion.

The gate driver 400 of the present embodiment is not necessarily arranged as shown in FIG. 9(a) and FIG. 9(b), as long as scanning signals G(1)-G(m) shown in d and e in FIG. 3 are generated. In the embodiment above, as shown in d and e in FIG. 3, each gate line GLj receives three black voltage applying pulses Pb in each frame period. However, the number of black voltage applying pulses Pb in one frame period, i.e. the number of times one gate line becomes selectable in a black signal insertion period in each frame period is not necessarily 3. The number of black voltage applying pulses is merely required to be not less than one, on condition that the display takes black level. As shown in F in FIG. 3, it is possible to set the black level (display brightness) in the black display period Tbk at a desired value by changing the number of the black voltage applying pulses Pb in one frame period.

In the embodiment above, furthermore, each gate line GLj receives the black voltage applying pulse Pb at a time point when the pixel data retaining period Thd having the length of ⅔ frame period elapses from the application of the pixel data writing pulse Pw (see d and e in FIG. 3), and in each frame black insertion of about ⅓ frame period is carried out. However, the black display period Tbk is not necessary equivalent to ⅓ frame period. The effect of impulse-type display is increased as the length of the black display period Tbk is increased, and the improvement in the moving image display capability (e.g. suppression of trailing afterimage) is prominent. However, the display brightness decreases. The black insertion period Tbk is therefore arranged in consideration of the effect of impulse-type display and the display brightness.

In the embodiment above, as shown in FIGS. 7 and 8, switching circuit by which the application of the data signals S(1)-S(n) to the source lines SL1-SLn during the charge sharing period Tsh is blocked and the source lines SL1-SLn (neighboring source lines) are caused to short-circuit one another are constituted by (i) the first MOS transistors SWa, (ii) either the second MOS transistors SWb and the third MOS transistors SWb2 or the second MOS transistors SWc, and (iii) the inverters 33, and the switching circuits are included in the source driver 300. Alternatively, at least one of the switching circuits may be provided outside the source driver 300, for example, a switching circuit is integrated with a pixel array in the display section 100, by adopting TFT.

In the present embodiment, the digital image signal DA that the display control circuit 250 supplies to the source driver 300 is pseudo-multi-bit time-division data. Alternatively, any types of digital image signals may be used. Also, the image signal that the display control circuit 250 supplies to the source driver 300 is not necessarily a digital signal. It is possible to adopt an arrangement such that in the display control circuit 250 the gamma characteristic is adjusted by processing a digital signal, and the data after the adjustment is supplied to the source driver after the conversion to an analog signal. The arrangement of the source driver may be suitably changed in accordance with the form of the signal.

### Embodiment 2

The following will discuss another embodiment of the present invention with reference to FIGS. 1-4 and FIGS. 6-13.

FIG. 11 is a block diagram showing a liquid crystal display apparatus 11 as a display apparatus of the present embodiment, together with an equivalent circuit of the display section. This liquid crystal display apparatus 11 includes: a source driver 300 as a data signal line drive circuit; a gate driver 400 as a scanning signal line drive circuit; an active-matrix display section 100; a display control circuit (gamma characteristic adjusting means) 251 for controlling the source driver 300 and the gate driver 400; ROMs 501 and 502; and a grayscale voltage source 700. Having these members, the liquid crystal display apparatus 11 can switch between a mode in which impulse-type display with black insertion is performed and a mode in which the impulse-type display is not performed, and can perform the selected mode. In the present embodiment, the present invention is described with the assumption that black is written in at the timing of a charge sharing period, e.g. when impulse-type display with black insertion is performed. However, charge sharing is not necessarily carried out, as long as impulse-type display is realized by black insertion. The inserted black is not necessarily a voltage corresponding to the minimum brightness, as long as a voltage corresponding to brightness within a predetermined range from the minimum brightness is eventually achieved. Hereinafter, impulse-type display realized by black insertion is simply termed as impulse-type display.

By the way, the source driver 300, gate driver 400, and the display section 100 are arranged in the same manner as those in Embodiment 1, and hence the descriptions thereof are omitted.

The display control circuit 251 receives, from an external signal source, a digital video signal Dv indicating an image to be displayed, a horizontal synchronization signal HSY and a vertical synchronization signal VSY which correspond to the digital video signal Dv, and a control signal Dc for controlling the display operation. Based on these signals Dv, HSY, VSY, and Dc, the display control circuit 250 generates and outputs, as signals for causing the display section 100 to display the image indicated by the digital video signal Dv, a data start pulse signal SSP, a data clock signal SCK, a charge share control signal Csh, a digital image signal DA (equivalent to the video signal Dv) representing the image to be displayed, a gate start pulse signal GSP, a gate clock signal GCK, and gate driver output control signals GOE.

After timing adjustment or the like is performed in an internal memory according to need, the video signal Dv is output from the display control circuit 251, as a digital image signal DA. The data clock signal SCK is generated as a signal by which the operation timing of a shift register in the source driver 300 is determined. The data start pulse signal SSP is generated as a signal which is changed based on the horizontal synchronization signal HSY to high level (H level) for a predetermined period of time in each horizontal scanning period, and is transferred in the shift register. The gate start pulse signal GSP is generated as a signal which is changed based on the vertical synchronization signal VSY to H level for a predetermined period time in each frame period (each vertical scanning period). The gate clock signal GCK is generated based on the horizontal synchronization signal HSY. The charge share control signal Csh and the gate driver output control signals GOE (GOE1-GOEq) are generated based on the horizontal synchronization signal HSY and the control signal Dc.

Among these signals generated by the display control circuit 251, the digital image signal DA, the charge share control signal Csh, the data start pulse signal SSP, and the data clock signal SCK are supplied to the source driver 300. The gate start pulse signal GSP, the gate clock signal GCK, and the gate driver output control signals GOE are supplied to the gate driver 400.

The display control circuit 251 is further provided with a switching circuit 251a. This switching circuit 251a receives, from the outside of the display control circuit 251, a control signal CSI on/off which control the turn-on/off of impulse-type display. Based on this control signal CSI on/off, the switching circuit 251a differentiates a grayscale reference voltage generated by the grayscale voltage source 700, between the mode in which impulse-type display is performed and the mode in which impulse-type display is not performed. Because of this arrangement, in the present embodiment, the gamma characteristic curve E2 shown in FIG. 4 is adjusted to conform to the gamma characteristic curve E1, in the mode in which impulse-type display is performed. In FIG. 4, for example, the brightness ratio of a point A corresponding to a grayscale n (normalizing grayscale) on the gamma characteristic curve E2 is adjusted to be equal to the brightness ratio of a point B corresponding to a grayscale n on the gamma characteristic curve E1, by arranging a grayscale reference voltage with which the brightness ratio at a point C corresponding to a grayscale n+k on the gamma characteristic curve E2 when no adjustment is performed to be equal to a grayscale reference voltage at a point B on the gamma characteristic curve E2 after the adjustment. Therefore the grayscale reference voltage at the point B on the grayscale characteristic curve E2 and the grayscale reference voltage at the point A on the gamma characteristic curve E1 correspond to the same grayscale n but are different from each other.

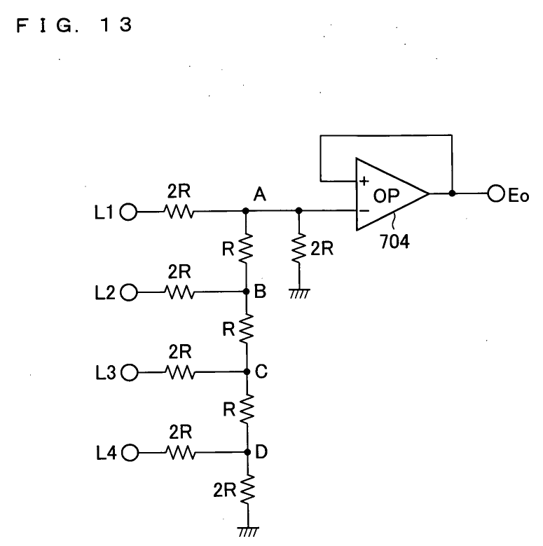

Therefore, as the grayscale voltage source 700, a D/A converter which can adjust the result of DA conversion by changing a set value of the register which is an input signal, as shown in FIG. 12 for example. The switching circuit 251a reads out, from the ROMs 501 and 502, a value to be set to each register of the grayscale voltage source 700. The ROM 501 stores register set values corresponding to grayscale reference voltages for the mode in which impulse-type display is performed (CSI on), whereas the ROM 502 stores register set values corresponding to grayscale reference voltages for the mode in which impulse-type display is not performed (CSI off). The switching circuit 251a sends the register set values read out from the ROM 501 or 502 based on the control signal CSI on/off to the grayscale voltage source 700 via an I²C bus.

The grayscale voltage source 700 receives the register set values by a terminal SDA and via an I²C bus interface 701, so that the register values are set in the respective registers (0 to A in FIG. 12). As a result a D/A conversion logic circuit 703 generates analog voltages corresponding to the register values. The generated analog voltages are buffered by a voltage follower 704 and output as grayscale reference voltages (V0-V9 in FIG. 12). These output grayscale reference voltages correspond to the voltages V0, V1, . . . , and Vp shown in FIG. 11.

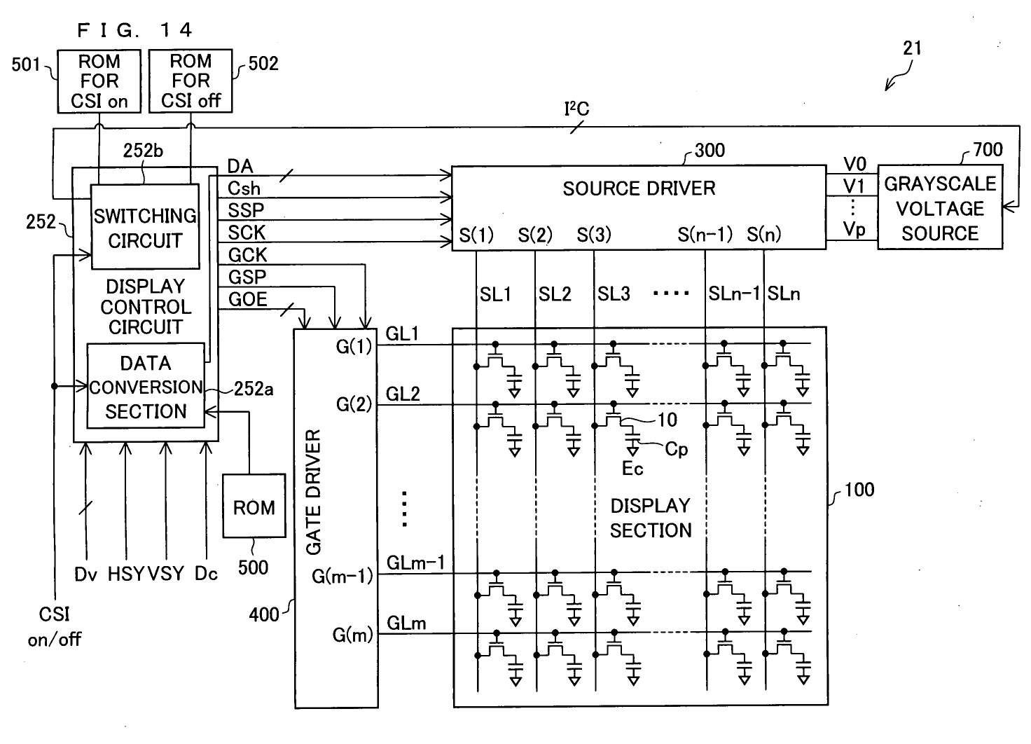

FIG. 13 shows an example of the aforesaid D/A converter. The D/A converter shown in FIG. 13 is a ladder-type D/A converter and includes three resistors R and six resistors 2R. In this arrangement, assume that, for example, the input digital signal (register value) is represented by 4 bits, the three resistors R are provided between nodes A and B, nodes B and C, and nodes C and D, respectively. The six resistors 2R are provided between a most significant bit input terminal L1 and the node A, a second most significant bit input terminal L2 and the node B, a third most significant bit input terminal L3 and the node C, a least significant bit input terminal L4 and the node D, the node A and GND, and the node D and GND, respectively. The input terminals L1 and L2 are equivalent to a single register 702 in FIG. 12, and the node A is equivalent to one output terminal of the D/A conversion logic circuit 703 in FIG. 12. The node A is connected to the input terminal of the voltage follower 704. The output terminal Eo of the voltage follower 704 shown in FIG. 13 is equivalent to one of the output terminals of the output voltages V0-V9 of the voltage follower 704.

With the arrangement shown in FIG. 13, the output terminal Eo receives a voltage which is generated in such a way that the register values supplied to the input terminals L1-L4 are weighted in accordance with the weights of the input terminals L1-L4.

In this way, in the present embodiment, the display control circuit 251 adjusts the gamma characteristic of display when, for each pixel, black insertion is performed during a predetermined period in one frame by applying a voltage in a predetermined horizontal blanking period, i.e. when impulse-type display by black insertion is performed. This makes it possible to improve the gamma characteristic by, for example, arranging the gamma characteristic of display with black insertion to conform to the gamma characteristic of display without black insertion.

As a result, it is possible to realize a display apparatus which can improve the gamma characteristic of display when impulse-type display by black insertion is performed.

In the present embodiment, in case of display with black insertion, the display control circuit 251 adjusts grayscale reference voltages selected as voltages corresponding to display data, so as to adjust the gamma characteristic. Adjusting the grayscale reference voltages selected as voltages corresponding to display data is equivalent to the adjustment of brightness ratio by changing a voltage applied to a pixel in response to the same display data. Therefore this makes it possible to easily adjust the gamma characteristic.

In the present embodiment, a voltage corresponding to display data is selected from grayscale reference voltages which are generated by a D/A converter as analog output voltages corresponding to an input digital signal. Therefore, when display with black insertion is performed, the display control circuit 251 inputs an input digital signal corresponding to a voltage corresponding to display data for the case of display with black insertion, so as to adjust the voltage corresponding to the display data.

According to this arrangement, when grayscale reference voltages are generated by the D/A converter and display with black insertion is performed, the display control circuit 251 adjusts the grayscale reference voltages only by converting an input digital signal of the D/A converter to an input digital signal corresponding to a voltage corresponding to display data in the case of the display with black insertion. It is therefore possible to achieve the adjustment of the gamma characteristic by using a general-purpose circuitry.

### Embodiment 3

The following will discuss a further embodiment of the present invention with reference to FIGS. 1-14.

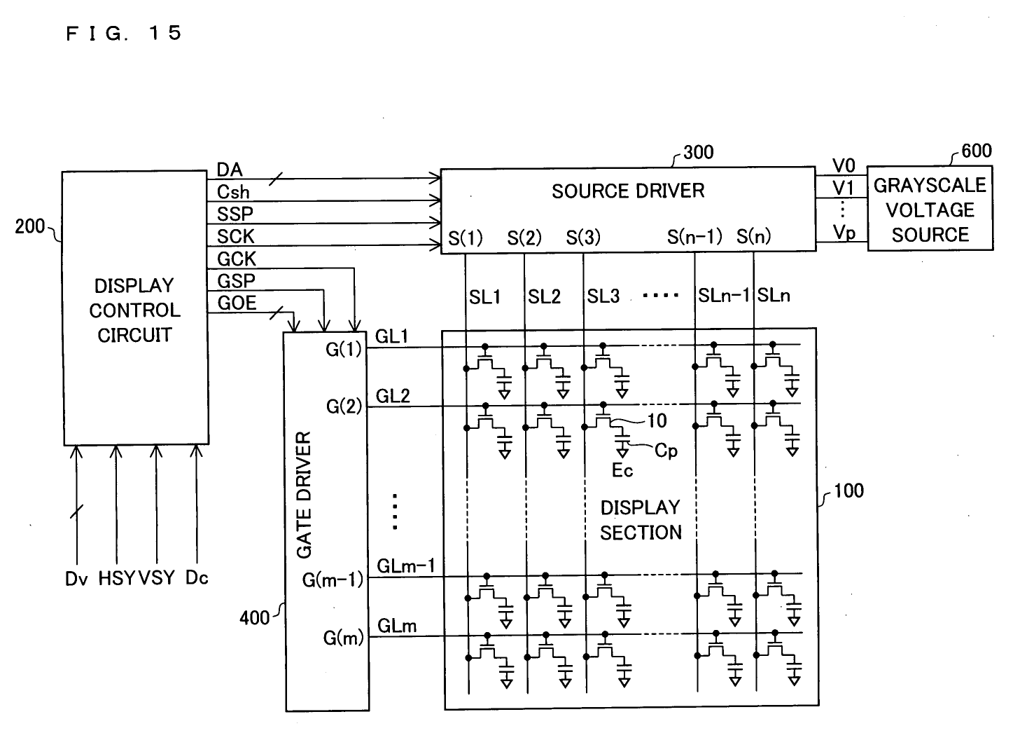

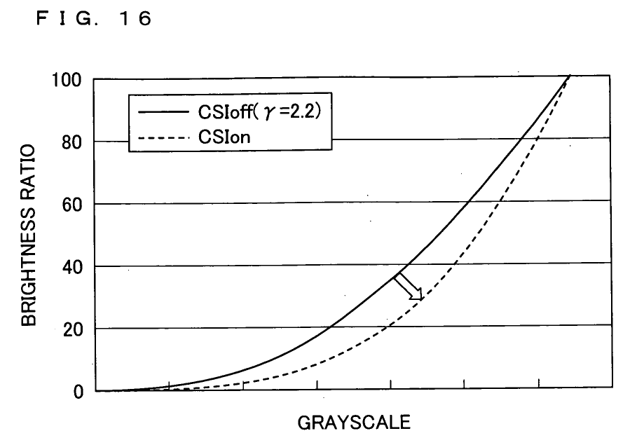

FIG. 14 is a block diagram showing a liquid crystal display apparatus 21 as a display apparatus of the present embodiment, together with an equivalent circuit of the display section. This liquid crystal display apparatus 21 includes: a source driver 300 as a data signal line drive circuit; a gate driver 400 as a scanning signal line drive circuit; an active-matrix display section 100; a display control circuit (gamma characteristic adjusting means) 251 for controlling the source driver 300 and the gate driver 400; ROMs 500, 501, and 502; and a grayscale voltage source 700. Having these members, the liquid crystal display apparatus 21 can switch between a mode in which impulse-type display with black insertion is performed and a mode in which the impulse-type display is not performed, and can perform the selected mode. In the present embodiment, the present invention is described with the assumption that black is written in at the timing of a charge sharing period, e.g. when impulse-type display with black insertion is performed. However, charge sharing is not necessarily carried out, as long as impulse-type display is realized by black insertion. The inserted black is not necessarily a voltage corresponding to the minimum brightness, as long as a voltage corresponding to brightness within a predetermined range from the minimum brightness is eventually achieved. Hereinafter, impulse-type display realized by black insertion is simply termed as impulse-type display.

By the way, the source driver 300, gate driver 400, the display section 100, the ROMs 500, 501, and 502, and the grayscale voltage source 700 are arranged in the same manner as those in Embodiments 1 and 2, and hence the descriptions thereof are omitted.

The display control circuit 252 includes a data conversion section 252a and a switching circuit 252b. The display control circuit can therefore perform both the adjustment of the gamma characteristic described in Embodiment 1 and the adjustment of the gamma characteristic described in Embodiment 2. The data conversion section 252a is arranged in the same manner as the data conversion section 250a shown in FIG. 1, whereas the switching circuit 252b is arranged in the same manner as the switching circuit 251a shown in FIG. 11. In this case, a control signal CSI on/off which controls the switching-on/off of impulse-type display is input, as a common signal, to the both of the data conversion section 252a and the switching circuit 252b.

Using information stored in the ROM 500, the data conversion section 252a adjusts a digital image signal DA so as to adjust the gamma characteristic. Also, using information stored in the ROMs 501 and 502, the switching circuit 252b adjusts grayscale reference voltages generated in the grayscale voltage source 700 so as to adjust the gamma characteristic. This can be suitably used for a case where, for example, the switching circuit 252b roughly adjust the gamma characteristic in the mode in which impulse-type display is performed, and the data conversion section 252a performs fine adjustment of the gamma characteristic in the mode in which impulse-type display is performed. That is to say, the adjustment of the gamma characteristic by the adjustment of grayscale reference voltages generated by the grayscale voltage source 700 can be easily performed even when the gamma characteristic is significantly different from a desired characteristic, but the precision of the adjustment may be insufficient. In such a case, the insufficiency is compensated by the adjustment of the gamma characteristic performed by the adjustment of the digital image signal DA.

In this way, in the present embodiment, the display control circuit 252 adjusts the gamma characteristic of display when, for each pixel, display with black insertion is performed only in a predetermined period in one frame by a voltage applied in a predetermined horizontal blanking period, i.e. when impulse-type display by black insertion is performed. This makes it possible to improve the gamma characteristic by, for example, arranging the gamma characteristic in case where display with black insertion is performed to conform to the gamma characteristic in case where display without black insertion is performed.

As a result it is possible to realize a display apparatus which can improve the gamma characteristic when impulse-type display by black insertion is performed.

The display apparatus of the present invention may be arranged such that, when the display with the black insertion is performed, the gamma characteristic adjusting means performs the adjustment of the gamma characteristic by adjusting the display data in a period other than the predetermined period.

According to this invention, the gamma characteristic adjusting means adjusts the gamma characteristic of the display by adjusting the display data in a period other than the predetermined period. It is therefore easy to adjust the gamma characteristic, and hence the gamma characteristic when display with black insertion is performed is improved.

The display apparatus of the present invention may be arranged such that, when the display with the black insertion is performed, the gamma characteristic adjusting means performs the adjustment of the gamma characteristic by adjusting grayscale reference voltages which are selected as the voltages corresponding to the display data.

According to this invention, adjustment of the grayscale reference voltages selected as the voltages corresponding to the display data is equivalent to the adjustment of the brightness ratio by changing voltages applied to the pixels in response to the same display data. Therefore this makes it possible to easily adjust the gamma characteristic.

The display apparatus of the present invention may be arranged such that, the voltages corresponding to the display data are selected from the grayscale reference voltages which are generated by a D/A converter as analog output voltages corresponding to an input digital signal, and when the display with the black insertion is performed, the gamma characteristic adjusting means inputs, to the D/A converter, the input digital signal corresponding to the voltages corresponding to the display data when the display with the black insertion is performed, so as to adjust the voltages corresponding to the display data.

According to this invention, when the grayscale reference voltages are generated by a D/A converter and display with black insertion is performed, the gamma characteristic adjusting means adjusts the grayscale reference voltages only by converting the input digital signal of the D/A converter into the input digital signal corresponding to the voltages corresponding to the display data when the display with the black insertion is performed. It is therefore possible to achieve the adjustment of the gamma characteristic by using a general-purpose circuitry.

The display apparatus of the present invention may be arranged such that, when the display with the black insertion is performed, the gamma characteristic adjusting means further adjusts the display data in a period other than the predetermined period so as to perform the adjustment of the gamma characteristic.

According to this arrangement, in addition to the adjustment of the gamma characteristic by the adjustment of the grayscale reference voltages, the display data of a period other than the predetermined period is adjusted so that the gamma characteristic is adjusted. The gamma characteristic is roughly adjusted by adjusting the grayscale reference voltages, and fine adjustment of the gamma characteristic is performed by adjusting the display data. By doing so, a desired gamma characteristic is achieved with precision, when it is not possible to sufficiently adjust the gamma characteristic by the adjustment of the grayscale reference voltages.

The display apparatus of the present invention may be arranged such that, as a result of the adjustment of the gamma characteristic, a gamma characteristic of the display with the black insertion is arranged to conform to a gamma characteristic of display without the black insertion.

This invention makes it possible to allow the gamma characteristic of the display with the black insertion to be good in the same manner as the gamma characteristic of the display without the black insertion.

A display apparatus of the present invention, which is an active matrix display apparatus performing display in such a way that voltages corresponding to display data are applied to pixels, the display apparatus being able to perform the display such that for each of the pixels black insertion is performed only during a predetermined period in one frame, may include gamma characteristic adjusting means for adjusting a gamma characteristic of the display in such a way that the gamma characteristic of the display is adjusted by adjusting the display data when the display without the black insertion is performed, and the gamma characteristic of the display is adjusted by adjusting the display data of a period other than the predetermined period, when the display with the black insertion is performed.

According to this invention, in both of the cases (i) where for each pixel black insertion is performed only in a predetermined period in one frame, i.e. when impulse-type display by black insertion is performed and (ii) where display without the black insertion is performed, the gamma characteristic adjusting means adjusts the gamma characteristic of the display. When display without black insertion is performed, the gamma characteristic adjusting means adjusts the gamma characteristic of the display by adjusting the display data. On the other hand, when display with black insertion is performed, the gamma characteristic adjusting means adjusts the gamma characteristic of display by adjusting display data of a period other than the predetermined period. As a result it is possible to easily adjust the gamma characteristic, thereby making it possible to improve the gamma characteristic when display with black insertion is performed.

When it is difficult to adjust the gamma characteristic when display with black insertion is performed to be close to the gamma characteristic when display without black insertion is performed, the gamma characteristic when display without black insertion is performed is arranged to be different from a desired gamma characteristic in advance, taking advantage of the nature that the gamma characteristic when display with black insertion is performed is different from the gamma characteristic when display without black insertion is performed. This makes it easily to arrange the gamma characteristics to be close to a desired gamma characteristic by adjusting both the gamma characteristic when display with black insertion is performed and the gamma characteristic when display without black insertion is performed.

As a result of the above, it is possible to realize a display apparatus which can improve the gamma characteristic of display when impulse-type display by black insertion is performed.

The display apparatus of the present invention may be arranged such that, a result of the adjustment of the gamma characteristic when the display without the black insertion is performed is arranged to conform to a result of the adjustment of the gamma characteristic when the display with the black insertion is performed.

This invention makes it possible to allow the gamma characteristic of the display with the black insertion to be good in the same manner as the gamma characteristic of the display without the black insertion.

The display apparatus of the present invention may be arranged such that the black insertion is conducted by a voltage which is applied during a predetermined blanking period which is determined for each of the pixels.

This invention makes it possible to improve the gamma characteristic of display by a display apparatus which performs black insertion by a voltage which is applied to a predetermined horizontal blanking period determined for each pixel.

The driving method of the present invention may be arranged such that, when the display with the black insertion is performed, the adjustment of the gamma characteristic is performed by adjusting the display data in a period other than the predetermined period.

According to this invention, the adjustment of the gamma characteristic of display is performed by adjusting display data in a period other than the predetermined period. It is therefore possible to easily adjust the gamma characteristic, thereby improving the gamma characteristic of display with black insertion.

The driving method of the present invention may be arranged such that, when the display with the black insertion is performed, the adjustment of the gamma characteristic is performed in such a way that grayscale reference voltages selected as the voltages corresponding to the display data are adjusted.

According to this invention, adjustment of the grayscale reference voltages selected as the voltages corresponding to the display data is equivalent to the adjustment of the brightness ratio by changing voltages applied to the pixels in response to the same display data. Therefore this makes it possible to easily adjust the gamma characteristic.

The driving method of the present invention may be arranged such that, the voltages corresponding to the display data are selected from the grayscale reference voltages generated by a D/A converter as analog output voltages corresponding to an input digital signal, and when the display with the black insertion is performed, the voltages corresponding to the display data are adjusted in such a way that, to the D/A converter, the input digital signal corresponding to the voltages corresponding to the display data in case of the display with the black insertion is supplied.

According to this invention, when the grayscale reference voltages are generated by a D/A converter and display with black insertion is performed, the grayscale reference voltages are adjusted only by converting the input digital signal of the D/A converter into the input digital signal corresponding to the voltages corresponding to the display data when the display with the black insertion is performed. It is therefore possible to achieve the adjustment of the gamma characteristic by using a general-purpose circuitry.

The driving method of the present invention may be arranged such that, when the display with the black insertion is performed, the adjustment of the gamma characteristic is performed by adjusting the display data of a period other than the predetermined period.

According to this arrangement, in addition to the adjustment of the gamma characteristic by the adjustment of the grayscale reference voltages, the display data of a period other than the predetermined period is adjusted so that the gamma characteristic is adjusted. The gamma characteristic is roughly adjusted by adjusting the grayscale reference voltages, and fine adjustment of the gamma characteristic is performed by adjusting the display data. By doing so, a desired gamma characteristic is achieved with precision, when it is not possible to sufficiently adjust the gamma characteristic by the adjustment of the grayscale reference voltages.

The driving method of the present invention may be arranged such that, by the adjustment of the gamma characteristic, a gamma characteristic of the display with the black insertion is arranged to conform to a gamma characteristic of the display without the black insertion.

This invention makes it possible to allow the gamma characteristic of the display with the black insertion to be good in the same manner as the gamma characteristic of the display without the black insertion.

A driving method of a display apparatus of the present invention, which is an active matrix display apparatus performing display in such a way that voltages corresponding to display data are applied to pixels, the display apparatus being able to perform the display such that for each of the pixels black insertion is performed only during a predetermined period in one frame, may be arranged in such a way that, a gamma characteristic of the display is adjusted by adjusting the display data, when the display without the black insertion is performed, whereas the gamma characteristic of the display is adjusted by adjusting the display data in a period other than the predetermined period, when the display with the black insertion is performed.

According to this invention, in both of the cases (i) where for each pixel black insertion is performed only in a predetermined period in one frame, i.e. when impulse-type display by black insertion is performed and (ii) where display without the black insertion is performed, the gamma characteristic adjusting means adjusts the gamma characteristic of the display. When display without black insertion is performed, the gamma characteristic adjusting means adjusts the gamma characteristic of the display by adjusting the display data. On the other hand, when display with black insertion is performed, the gamma characteristic adjusting means adjusts the gamma characteristic of display by adjusting display data of a period other than the predetermined period. As a result it is possible to easily adjust the gamma characteristic, thereby making it possible to improve the gamma characteristic when display with black insertion is performed.

When it is difficult to adjust the gamma characteristic when display with black insertion is performed to be close to the gamma characteristic when display without black insertion is performed, the gamma characteristic when display without black insertion is performed is arranged to be different from a desired gamma characteristic in advance, taking advantage of the nature that the gamma characteristic when display with black insertion is performed is different from the gamma characteristic when display without black insertion is performed. This makes it easily to arrange the gamma characteristics to be close to a desired gamma characteristic by adjusting both the gamma characteristic when display with black insertion is performed and the gamma characteristic when display without black insertion is performed.

As a result of the above, it is possible to realize a driving method of a display apparatus which can improve the gamma characteristic of display when impulse-type display by black insertion is performed.

The driving method of the present invention may be arranged such that, a result of the adjustment of the gamma characteristic when the display without the black insertion is performed is arranged to conform to a result of the adjustment of the gamma characteristic when the display with the black insertion is performed.

This invention makes it possible to allow the gamma characteristic of the display with the black insertion to be good in the same manner as the gamma characteristic of the display without the black insertion.

The driving method of the present invention may be arranged such that, the black insertion is performed by a voltage applied in a predetermined horizontal blanking period which is determined for each of the pixels.

This invention makes it possible to improve the gamma characteristic of display by a driving method of a display apparatus which performs black insertion by a voltage which is applied to a predetermined horizontal blanking period determined for each pixel.

### INDUSTRIAL APPLICABILITY

The present invention can be suitably used for a liquid crystal display apparatus.

1. A display apparatus which is an active matrix display apparatus performing display in such a way that voltages corresponding to display data are applied to pixels, the display apparatus being able to perform the display such that for each of the pixels black insertion is performed only during a predetermined period in one frame,
the display apparatus being characterized by comprising gamma characteristic adjusting means for adjusting a gamma characteristic of the display when the display with the black insertion is performed.

2. The display apparatus as defined in claim 1,
wherein, when the display with the black insertion is performed, the gamma characteristic adjusting means performs the adjustment of the gamma characteristic by adjusting the display data in a period other than the predetermined period.

3. The display apparatus as defined in claim 1,
wherein, when the display with the black insertion is performed, the gamma characteristic adjusting means performs the adjustment of the gamma characteristic by adjusting grayscale reference voltages which are selected as the voltages corresponding to the display data.

4. The display apparatus as defined in claim 3,
wherein, the voltages corresponding to the display data are selected from the grayscale reference voltages which are generated by a D/A converter as analog output voltages corresponding to an input digital signal, and
when the display with the black insertion is performed, the gamma characteristic adjusting means inputs, to the D/A converter, the input digital signal corresponding to the voltages corresponding to the display data when the display with the black insertion is performed, so as to adjust the voltages corresponding to the display data.

5. The display apparatus as defined in claim 3,
wherein, when the display with the black insertion is performed, the gamma characteristic adjusting means further adjusts the display data in a period other than the predetermined period so as to perform the adjustment of the gamma characteristic.

6. The display apparatus as defined in claim 1,
wherein, as a result of the adjustment of the gamma characteristic, a gamma characteristic of the display with the black insertion is arranged to conform to a gamma characteristic of display without the black insertion.

7. A display apparatus which is an active matrix display apparatus performing display in such a way that voltages corresponding to display data are applied to pixels, the display apparatus being able to perform the display such that for each of the pixels black insertion is performed only during a predetermined period in one frame,
the display apparatus being characterized by comprising gamma characteristic adjusting means for adjusting a gamma characteristic of the display in such a way that the gamma characteristic of the display is adjusted by adjusting the display data when the display without the black insertion is performed, and the gamma characteristic of the display is adjusted by adjusting the display data of a period other than the predetermined period, when the display with the black insertion is performed.

8. The display apparatus as defined in claim 7,
wherein, a result of the adjustment of the gamma characteristic when the display without the black insertion is performed is arranged to conform to a result of the adjustment of the gamma characteristic when the display with the black insertion is performed.

9. The display apparatus as defined in claim 1,
wherein, the black insertion is conducted by a voltage which is applied during a predetermined blanking period which is determined for each of the pixels.

10. A driving method of a display apparatus which is an active matrix display apparatus performing display in such a way that voltages corresponding to display data are applied to pixels, the display apparatus being able to perform display such that for each of the pixels black insertion is performed only during a predetermined period in one frame,
the driving method being characterized in that a gamma characteristic of display is adjusted when display with the black insertion is performed.

11. The driving method as defined in claim 10,
wherein, when the display with the black insertion is performed, the adjustment of the gamma characteristic is performed by adjusting the display data in a period other than the predetermined period.

12. The driving method as defined in claim 10,
wherein, when the display with the black insertion is performed, the adjustment of the gamma characteristic is performed in such a way that grayscale reference voltages selected as the voltages corresponding to the display data are adjusted.

13. The driving method as defined in claim 12,
wherein, the voltages corresponding to the display data are selected from the grayscale reference voltages generated by a D/A converter as analog output voltages corresponding to an input digital signal, and
when the display with the black insertion is performed, the voltages corresponding to the display data are adjusted in such a way that, to the D/A converter, the input digital signal corresponding to the voltages corresponding to the display data in case of the display with the black insertion is supplied.

14. The display apparatus as defined in claim 12,
wherein, when the display with the black insertion is performed, the adjustment of the gamma characteristic is performed by adjusting the display data of a period other than the predetermined period.

15. The driving method as defined in claim 10,
wherein, by the adjustment of the gamma characteristic, a gamma characteristic of the display with the black insertion is arranged to conform to a gamma characteristic of the display without the black insertion.

16. A driving method of a display apparatus which is an active matrix display apparatus performing display in such a way that voltages corresponding to display data are applied to pixels, the display apparatus being able to perform the display such that for each of the pixels black insertion is performed only during a predetermined period in one frame,
the driving method being characterized in that, a gamma characteristic of the display is adjusted by adjusting the display data, when the display without the black insertion is performed, whereas the gamma characteristic of the display is adjusted by adjusting the display data in a period other than the predetermined period, when the display with the black insertion is performed.

17. The driving method as defined in claim 16,
wherein, a result of the adjustment of the gamma characteristic when the display without the black insertion is performed is arranged to conform to a result of the adjustment of the gamma characteristic when the display with the black insertion is performed.

18. The driving method as defined in claim 10,
wherein, the black insertion is performed by a voltage applied in a predetermined horizontal blanking period which is determined for each of the pixels.

19. The display apparatus as defined in claim 7,
wherein, the black insertion is conducted by a voltage which is applied during a predetermined blanking period which is determined for each of the pixels.

20. The driving method as defined in claim 16,
wherein, the black insertion is performed by a voltage applied in a predetermined horizontal blanking period which is determined for each of the pixels.
